(19) United States
(12) Patent Application Publication
(10) Pub. No.: US 2021/0253611 A1
(43) Pub. Date: Aug. 19, 2021

(54) TETRA-NUCLEAR NEUTRAL COPPER (I) COMPLEXES WITH DIARYLPHOSPHINE LIGANDS

(71) Applicant: Clariant International Ltd, Muttenz (CH)

(72) Inventors: Damien BISSESSAR, Strasbourg (FR); Stephane BELLEMIN LAPONNAZ, Strasbourg (FR); Pascal STEFFANUT, Village Neuf (FR)

(73) Assignee: Clariant International Ltd, Muttenz (CH)

(21) Appl. No.: 17/253,379

(22) PCT Filed: Jun. 21, 2019
(86) PCT No.: PCT/EP2019/066484

§ 371 Date: Dec. 17, 2020

(30) Foreign Application Priority Data
Jun. 20, 2018 (EP) 18178816.7

(51) Int. Cl. C07F 9/50; C08F 4/50

(52) U.S. Cl. CPC C07F 9/5045; C08F 4/50

(57) ABSTRACT

The present invention relates to tetra-nuclear neutral copper (I) complexes that have a cubane-like structure, wherein said complexes further comprise diarylphosphine ligands which are bonded via phosphorus atoms. Furthermore, the present invention refers to methods for generating such copper (I) complex and to uses thereof. The present invention further relates to cubane-like conjugates that comprise moiety of the copper (I) complexes of the invention. Formula (A), each L is independently from each other an optionally substituted diary lphosphine residue of Formula (A1): PHSr₂ (A1).

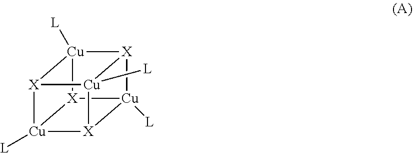

The present invention relates to tetra-nuclear neutral copper (I) complexes that have a cubane-like structure, wherein said complexes further comprise diarylphosphine ligands which are bonded via phosphorus atoms. Furthermore, the present invention refers to methods for generating such copper (I) complex and to uses thereof. The present invention further relates to cubane-like conjugates that comprise a moiety of the copper (I) complexes of the invention.

Today, compounds for optochemical uses are of interest for various applications. For example, such compounds are used in opto-electronic device, as stabilizers in thermoplastic molding masses and for modifying light transmission of a material such as, e.g., in a polymer material. For the above applications, it is of interest to provide chemically and physically stable compounds with good photophysical properties. In several applications, it is of interest to immobilize the compounds on solid supports or within polymer matrices. One structural class of compounds with particularly good photophysical properties comprises diarylphosphine residues.

The usability of compounds for optochemical uses comprising diarylphosphine moieties is, however, still limited due to their poor environmental stability. Diarylphosphine moieties are often highly sensitive to air and higher temperatures. Complexes that comprise diarylphosphine moieties and copper halides (such as Cu(I)) have been described (Abel et al., J. Chem. Soc. A (Inorg. Phys. Theor.), 1969, pages 133-136). These complexes were prepared at low temperatures by dropwise addition of the phosphine ligand to a cooper halide and showed absorption maxima of clearly below 300 nm. No light emission was found. Further, Abel et al. describes a variety of complexes having different stoichiometry including complexes having the general formula [Ph₂PHCuX]₄ wherein X is a halogen. The exact chemical structure of such complexes is, however, not taught. The specific experimental part thereof focuses on [Ph₂PHCuX] and not a structure that comprises four copper atoms. Abel et al. does not describe cubane-like copper (I) complexes.

Issleib and Wilde (Zeitschrift für Anorganische und Allgemeine Chemie, 1961, 312:287-298) and Issleib and Wenschuh (Zeitschrift für Anorganische und Allgemeine Chemie, 1960, 305:15-24) describe complexes comprising heavy metals such as iron, cobalt, palladium, copper or nickel, phosphine ligands, and chloride or bromide. These documents teach that the complexes may have different shapes such as planar, trigonal, octahedral, or tetraedric structures.

US-A 2005/079384 describes a wide variety of complexes comprising copper-containing cubane-like complexes which may be conjugated with nitrogen- or phosphorous-containing ligands preferably comprising each two alkyl or aromatic substituents.

Vega and Saillard (Inorg. Chem., 2004, 43:4012-4018) is a theoretical investigation (DFT calculation) of cluster-type copper complexes which may contain large variety of further ingredients.

There is still an unmet need for air stable and thermally stabile diarylphosphine compounds with good photophysical properties. Preferably, these diarylphosphine compounds should emit light in the visible range. It is further desirable that the diarylphosphine compounds can easily be further reacted to form conjugates with other structures or solid supports and thereby maintain their beneficial photophysical properties.

Surprising, it has been found that complexes based on copper (I) and halide having a cubane-like structure could effectively stabilize diarylphosphine ligands. The obtained copper (I) complexes could be prepared without burden and in good yields and were found to have good air and thermal stability. Therefore, these copper (I) complexes may be, for example, used for in polymerization reactions and may be chemically conjugated to various structures, while the spectral photophysical properties are maintained or improved.

A first aspect of the present invention relates to a copper (I) complex of Formula (A)

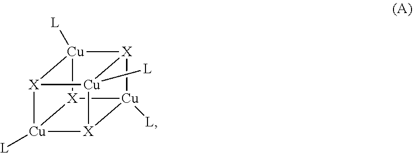

wherein:

each Cu is copper (I);

each X is independently from each other halogen;

each L is independently from each other an optionally substituted diarylphosphine

residue of Formula (A1):

PHAr₂ (A1),

wherein:

P is phosphorus;

H is hydrogen; and

each Ar is independently from each other an aryl residue that is unsubstituted or substituted by one or more substituents, wherein a substituent may optionally be or contribute to a linker that interconnects two ligands L with another;

wherein the phosphorus is bound to Cu; and

wherein said copper (I) complex has a neutral net charge.

It will be understood that the structure of Formula (A) is a cubane-like copper (I) complex with four phosphine ligands., in other words a cubane-like [copper (I)—halogen—phosphine] complex with a [Cu4×4] cubane core. The ligand L may also be designated as a hydrogenophosphine ligand or hydrogenodiarylphosphine ligand, which is bonded to a copper atom via one phosphorus atom. As laid out above, in the copper (I) complex (Cu(I) complex) of the present invention, the ligands L may optionally also be bonded to one another, giving rise to a bivalent ligand.

In a preferred embodiment, the copper (I) complex of the present invention is such according to Formula (A-i):

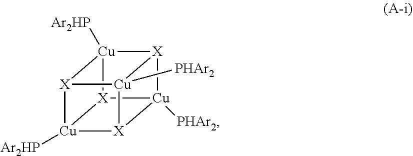

wherein:

each Cu is copper (I);

each X is independently from each other halogen;

each P is phosphorus;

each H is hydrogen; and

each Ar is independently from each other an unsubstituted or substituted aryl residue,

wherein said copper (I) complex has a neutral net charge.

The copper (I) complex of the present invention has a neutral net charge. Accordingly, preferably, all ligands L also each have a neutral net charge. As used herein, the term “neutral net charge” may be understood in the broadest sense as not having a charge (positive (+) or negative (−)) over the whole compound or moiety, i.e., have net zero charge. More preferably, the ligands L do not have an ionic group at all in other words, are uncharged. Alternatively, one or more of the ligands L may be zwitterionic. In the latter case, the copper (I) complex of the present invention may also be a salt of the Formula (A).

As used throughout the present application, the term “aryl” may be understood in the broadest sense as any mono-, bi- or polycyclic aromatic moiety. Preferably, an aryl is a C₆-C₃₀-aryl, more preferably a C₆-C₁₄-aryl, even more preferably a C₆-C₁₀-aryl, in particular a C₆-aryl. The term “heteroaryl” may be understood in the broadest sense as any mono-, bi- or polycyclic heteroaromatic moiety that includes at least one heteroatom, in particular which bears from one to three heteroatoms per aromatic ring. Preferably, a heteroaryl is a C₁-C₂₉-aryl, more preferably a C₁-C₁₃-aryl, even more preferably a C₁-C₉-aryl, in particular a C₁-C₅-aryl. Accordingly, the terms “arylene” and “heteroarylene” refer to the respective bivalent residues that each bear two binding sites to other molecular structures and thereby serve as a linker structure. Exemplarily, a heteroaryl may be a residue of furan, pyrrole, imidazole, oxazole, thiazole, triazole, thiophene, pyrazole, pyridine, pyrazine or pyrimidine. As far as not otherwise indicated, an aryl or heteroaryl may also be optionally substituted by one or more substituents. In other words an n aryl or heteroaryl may be unsubstituted or substituted.

As used throughout the present application, the term “unsubstituted” may be understood in the broadest sense as generally understood in the art. Thus, in accordance with general understanding, an unsubstituted residue may consist of the chemical structure defined and, as far as appropriate, one or more hydrogen atoms bound to balance valency.

As used throughout the present application, the term “substituted” may be understood in the broadest sense as generally understood in the art. Thus, a substituted residue may comprise the chemical structure described and one or more substituents. In other words, one or more hydrogen atoms balancing valency are typically replaced by one or more other chemical entities. Preferably, a substituted residue comprises the chemical structure described and one substituent. In other words, then, one hydrogen atom balancing valency is replaced by another chemical entity. For instance, a substituent may be an atom or a group of atoms which replaces one or more hydrogen atoms on the parent chain of a hydrocarbon residue.

As far as not otherwise defined herein, a substituent may be any substituent. Preferably, a substituent does either not comprise more than 30 carbon atoms. For example, a substituent may be selected from the group consisting of —R^{a}—R^{b}, —R^{a}—CO—O—R^{b}, —R^{a}—O—CO—R^{b}, —R^{a}—O—R^{b}, —R^{a}—CO—NH—R^{b}, or —R^{a}—NH—CO—R^{b}, —R^{a}—NH—R^{b}, —R^{a}—CO—R^{b}, (preferably alkyl terminated) di- or polyethylene glycol, di- or polypropylene glycol, and a halogen, wherein

R^{a} is an a single bond, (unsubstituted or substituted) C₁-C₂₀-alkylene residue, an (unsubstituted or substituted) C₂-C₂₀-alkenylene residue, or an (unsubstituted or substituted) C₂-C₂₀-alkinylene residue; and

R^{b} is an (unsubstituted or substituted) C₁-C₂₀-(hetero)alkyl residue, an (unsubstituted or substituted) C₁-C₂₀-(hetero)alkenyl residue, an (unsubstituted or substituted) C₁-C₂₀-(hetero)alkinyl residue, an (unsubstituted or substituted) C₁-C₂₀-(hetero)cycloalkyl residue, an (unsubstituted or substituted) C₁-C₂₀-(hetero)cycloalkenyl residue, an (unsubstituted or substituted) C₁-C₂₀-(hetero)cycloalkinyl residue, or an (unsubstituted or substituted) C₁-C₂₀-(hetero)aromatic residue,

wherein preferably the substituent (as a whole) does either not comprise more than 30 carbon atoms.

More preferably, the substituent (as a whole) does either not comprise more than 20 carbon atoms, even more preferably not more than 10 carbon atoms, in particular not more than 4 carbon atoms. The person skilled in the art will immediately understand that the definitions of R^{a} and R^{b} have to be adapted accordingly.

For example, in a particularly preferred embodiment, the defined residues are unsubstituted or are substituted with one substituent that does not comprise more than 4 carbon atoms, wherein a substituent may be selected from the group consisting of —R^{a}—R^{b}, —R^{a}—CO—O—R^{b}, —R^{a}—O—CO—R^{b}, —R^{a}—O—R^{b}, —R^{a}—CO—NH—R^{b}, or —R^{a}—NH—CO—R^{b}, —R^{a}—NH—R^{b}, —R^{a}—CO—R^{b}, (preferably alkyl terminated) di- or polyethylene glycol, or di- or polypropylene glycol,

R^{a} is an unsubstituted C₁-C₄-alkylene residue, an unsubstituted C₂-C₄-alkenylene residue, or an unsubstituted C₂-C₄-alkinylene residue; and R^{b} is an unsubstituted C₁-C₄-(hetero)alkyl residue, an unsubstituted C₁-C₄-(hetero)alkenyl residue, an unsubstituted C₁-C₄-(hetero)alkinyl residue, an unsubstituted C₁-C₄-(hetero)cycloalkyl residue, an unsubstituted C₁-C₄-(hetero)cycloalkenyl residue, an unsubstituted C₁-C₄-(hetero)cycloalkinyl residue, or an (unsubstituted or substituted) C₁-C₄-(hetero)aromatic residue.

In a preferred embodiment, a substituent may be selected from the group consisting of —R^{a}—R^{b}, —R^{a}—CO—O—R^{b}, —R^{a}—O—CO—R^{b}, —R^{a}—O—R^{b}, (preferably alkyl terminated) di- or polyethylene glycol, or di- or polypropylene glycol, wherein R^{a} and R^{b} are defined as above.

In a particularly preferred embodiment, a substituent is selected from the group consisting of —R^{a}—R^{b}, —R^{a}—CO—O—R^{b}, —R^{a}—O—CO—R^{b}, —R^{a}—O—R^{b}, wherein R^{a} and R^{b} are defined as above and the substituent does not comprise more than 30 carbon atoms, more preferably does not comprise more than 20 carbon atoms, even more preferably does not comprise more than 10 carbon atoms, in particular does not comprise more than 4 carbon atoms. The person skilled in the art will immediately understand that the definitions of R^{a} and R^{b} have to be adapted accordingly as laid out above.

As used throughout the present application, the term “alkyl” may be understood in the broadest sense as both, linear or branched chain alkyl residue. Preferred alkyl residues are those containing from one to 20 carbon atoms. More preferred alkyl residues are those containing from one to ten carbon atoms. Particularly preferred alkyl residues are those containing from one to four carbon atoms. Exemplarily, an alkyl residue may be methyl, ethyl, propyl, isopropyl, butyl, isobutyl or tert-butyl. The term “heteroalkyl” may be understood in the broadest sense as both, linear or branched chain alkyl residue that includes at least one heteroatom, in particular which bears from one to three heteroatoms. Typically, the heteroatom may replace a carbon atom. It will be understood that the valency will be adapted accordingly throughout the present application. As far as not otherwise indicated, an alkyl or heteroalkyl may also be optionally substituted by one or more substituents. A (hetero)cycloalkyl refers to the respective cyclic structure that is typically an aliphatic cyclic structure. The terms “alkylene”, “heteroalkylene”, “cycloalkylene” and “heterocycloalkylene” refer to bivalent residues that each bear two binding sites to other molecular structures and thereby serve as a linker structure.

As used throughout the present invention, an heteroatom may be any heteroatom, in particular a di-, tri- or tetravalent atom, such as, e.g., oxygen, nitrogen, sulfur, silicium, or a combination of two or more thereof, which may be optionally further substituted. It will be understood that when an heteroatom replaces a carbon atom, the valency and number or hydrogen atoms will be adapted accordingly. Accordingly, a residue comprising one or more heteroatoms may, for example, comprise a group selected from —O—, —NH—, ═N—, —NCH₃—, —Si(OH₂)—, —Si(OH)CH₃—, —Si(CH₃)₂—, —O—Si(OH)₂—O—, —O—Si(OH)CH₃—O—, —O—Si(CH₃)₂—O—, —S—, —SO—, —SO₂—, —SO)₃—, —SO₄—, or a salt thereof.

As used throughout the present application, the term “alkenyl” may be understood in the broadest sense as both, linear or branched chain alkenyl residue, i.e. a hydrocarbon comprising at least one double bond. An alkenyl may optionally also comprise two or more double bonds. Preferred alkenyl residues are those containing from two to 20 carbon atoms. More preferred alkenyl residues are those containing from two to ten carbon atoms. Particularly preferred alkenyl residues are those containing from two to four carbon atoms. The term “heteroalkenyl” may be understood in the broadest sense as both, linear or branched chain alkenyl residue that includes at least one heteroatom, in particular which bears from one to three heteroatoms. As far as not otherwise indicated, an alkenyl or heteroalkenyl may also be optionally substituted by one or more substituents. A (hetero)cycloalkenyl refers to the respective cyclic structure that is typically an aliphatic cyclic structure. The terms “alkenylene”, “heteroalkenylene”, “cycloalkenylene” and “heterocycloalkenylene” refer to bivalent residues that each bear two binding sites to other molecular structures and thereby serve as a linker structure.

As used throughout the present application, the term “alkinyl” may be understood in the broadest sense as both, linear or branched chain alkinyl residue, i.e. a hydrocarbon comprising at least one double bond. An alkinyl may optionally also comprise two or more double bonds. Preferred alkinyl residues are those containing from two to 20 carbon atoms. More preferred alkinyl residues are those containing from two to ten carbon atoms. Particularly preferred alkinyl residues are those containing from two to four carbon atoms. The term “heteroalkinyl” may be understood in the broadest sense as both, linear or branched chain alkinyl residue that includes at least one heteroatom, in particular which bears from one to three heteroatoms. As far as not otherwise indicated, an alkinyl or heteroalkinyl may also be optionally substituted by one or more substituents. A (hetero)cycloalkinyl refers to the respective cyclic structure that is typically an aliphatic cyclic structure. The terms “alkinylene”, “heteroalkinylene”, “cycloalkinylene” and “heterocycloalkinylene” refer to bivalent residues that each bear two binding sites to other molecular structures and thereby serve as a linker structure.

It will be noticed that hydrogen can, at each occurrence, be replaced by deuterium. Each X in the copper (I) complex of Formula (A) may be any halogen. In a preferred embodiment, each X is of the same kind. In other words, when each X is of the same kind, the copper (I) complex of the present invention merely comprises a single type of X only. Then, the cubane-like core comprises a single type of halogen only. In still other words, then, the sum formula of the cubane-like core is Cu₄X₄.

Each X may independently from each other be iodine (I), bromine (Br), chlorine (Cl), fluorine (F), or astatine (At). Preferably, each X is independently from each other selected from the group consisting of iodine (I), bromine (Br), chlorine (Cl), and fluorine (F). More preferably, each X is independently from each other selected from the group consisting of iodine (I), bromine (Br), and chlorine (Cl). Even more preferably, each X is independently from each other selected from the group consisting of iodine (I) and bromine (Br). In a particularly preferred embodiment, each X is iodine. In other words, in a particularly preferred embodiment, the cubane-like core comprises a iodine as halogen only. In still other words, then, the sum formula of the cubane-like core is Cu₄Cl₄. In still other words, the all of X are each iodine.

In a preferred embodiment, each Ar is independently from each other a phenyl residue Ph that is unsubstituted or substituted by one or more substituents, wherein each substituent may optionally be or contribute to a linker that interconnects two ligands L with another.

In this context, the ligand L may also be designated as a hydrogenodiphenylphosphine ligand, which is bonded to a copper atom via one phosphorus atom.

In a preferred embodiment of the present invention, the copper (I) complex of the present invention has the following structure of formula (A-ii):

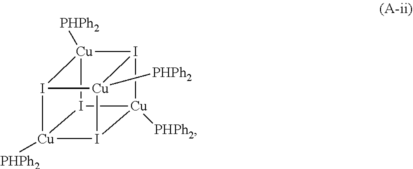

wherein:

each Cu is copper (I);

each I is iodine;

each P is phosphorus; and

each Ph is an unsubstituted or substituted phenyl residue.

In a more preferred embodiment, each Ar is independently from each other a phenyl residue Ph that is unsubstituted or substituted by one or more substituents each independently from each other selected from the group consisting of a linear or branched, unsubstituted or substituted C₁-C₂₀-alkyl residue, a linear or branched, unsubstituted or substituted C₁-C₁₂-alkoxy residue and halogen, wherein each substituent may optionally be or contribute to a linker that interconnects two ligands L with another.

In a preferred embodiment, each ligand L independently from each other has a structure of Formula (A2)

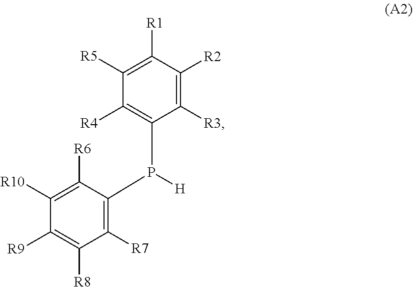

wherein R1 to R10 are independently from each other selected from the group consisting of hydrogen, a linear or branched, unsubstituted or substituted C₁-C₂₀-alkyl residue, or a linear or branched, unsubstituted or substituted C₁-C₁₂-alkoxy residue,

wherein the phosphorus is bound to Cu.

In a more preferred embodiment, each ligand L independently from each other has a structure of Formula (A2), wherein R1 to R10 are independently from each other selected from the group consisting of hydrogen, a unsubstituted C₁-C₂₀-alkyl residue, or a unsubstituted C₁-C₁₂-alkoxy residue.

In an even more preferred embodiment, each ligand L independently from each other has a structure of Formula (A2), wherein R1 to R10 are independently from each other selected from the group consisting of hydrogen, an unsubstituted C₁-C₆-alkyl residue, or a unsubstituted C₁-C₆-alkoxy residue.

In an even more preferred embodiment, each ligand L independently from each other has a structure of Formula (A2), wherein R1 to R10 are independently from each other selected from the group consisting of hydrogen and a unsubstituted C₁-C₄-alkyl residue. Thus, in a highly preferred embodiment, each of R1 to R10 is independently from each other selected from the group consisting of hydrogen, methyl, ethyl, n-propyl, iso-propyl, or a C₄-alkyl.

In a highly preferred embodiment, each ligand L independently from each other has a structure of Formula (A2), wherein at least six of residues R1 to R10 are hydrogen, more preferably at least seven of residues R1 to R10 are hydrogen, even more preferably at least eight of residues R1 to R10 are hydrogen, even more preferably at least nine of residues R1 to R10 are hydrogen.

In a particularly preferred embodiment, all of residues R1 to R10 are hydrogen.

The ligands L may be of the same kind or may be different. Preferably, at least two ligands L may be of the same kind, more preferably at least three ligands L may be of the same kind. In a more preferred embodiment, each ligand L is a monovalent ligand of the same kind. In other words, when each ligand L is a monovalent ligand of the same kind, the copper (I) complex of the present invention merely comprises a single type of ligand L.

In an alternative preferred embodiment, two ligands L are interconnected with another, thereby forming a bivalent ligand. More preferably, two times each two ligands L are interconnected with another, thereby each forming a bivalent ligand. Even more preferably, two times each two ligands L of the same kind are interconnected with another, thereby forming two bivalent ligands of the same kind.

In a highly preferred embodiment, the copper (I) complex has the following structure or Formula (A3):

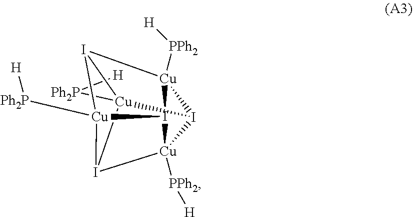

wherein each Ph is independently from each other an unsubstituted or substituted phenyl residue.

Particularly preferably, the copper (I) complex has the following structure or Formula (A3), wherein each Ph is an unsubstituted phenyl residue. This compound may also be designated as a CuI-diphenylphosphine complex having cubane-like structure or CuI-hydrogenodiphenylphosphine complex having cubane-like structure.

A copper (I) complex of the present invention may be prepared by any means. The present invention, however, also refers to means for preparing a copper (I) complex of the present invention.

A further aspect of the present invention relates to a method for generating a copper (I) complex of the present invention, said method comprising the following steps:
(i) providing, in an inert atmosphere:
   (a) copper (I) halide,
   (b) an electronically neutral substituted ligand L as defined above, and
   (c) a solvent in which components (a) and (b) are dissolved;
(ii) incubating the composition of step (i) at conditions allowing the formation of the copper (I) complex; and
(iii) optionally removing the solvent and obtaining a solid residue; and
(iv) optionally mixing the composition of step (ii) or a solution obtained by dissolving the solid residue of step (iii) with an anti-solvent, thereby forming a precipitate, and subsequently drying the precipitate.

It will be understood that the definitions and preferred embodiments as laid out in the context of the copper (I) complex of the present invention above mutatis mutandis apply to the method for preparing such.

Step (i) of providing the components (a)-(c) may be performed by any means. Preferably, the components (a)-(c) are provided in the (essential) absence of water, in particular in the (essential) absence of water and oxygen. Accordingly, (essentially) water-free solvent is used. The components (a)-(c) may be provided by any means for providing an inert atmosphere such as, e.g., an airproof container. in any type of airproof container. Such airproof container may be a Schlenck tube. Such airproof container may be flame-dried. It will be understood, that, in particular at an industrial scale, also other airproof containers may be used. For providing an inert atmosphere, any protection gas (also : inert gas) may be used. For example a noble gas (e.g., argon) or nitrogen may be used as an inert atmosphere. Preferably, an inert atmosphere may be under argon atmosphere.

Copper (I) halide (also copper (I) halogenide) may be any salt composed of copper (I) ions (Cu⁺) and halide ions (X⁻), i.e., any CuX salt. Preferably, only a single type of halide is used. The copper (I) halide may be CuI, CuBr, CuCl, CuF or CuAt. Preferably, the copper (I) halide is CuI, CuBr, CuCl or CuF, more preferably CuI, CuBr or CuCl, even more preferably CuI or CuBr. In particular, the copper (I) halide is CuI (copper (I) iodide).

The ligand may be an electronically neutral substituted ligand L and may be such as defined above, in particular an unsubstituted or substituted diphenylhoshine ligand (PHPh₂). Preferably, only a single kind of ligand is used. Alternatively, also bivalent ligands may be used.

The solvent may be any solvent usable to dissolve components (a) and (b), i.e., the copper (I) halide and the electronically neutral substituted ligand L. Preferably, the solvent is (essentially) free of water, in other words, is a dry solvent. It will be understood that the solvent may also be a mixture of two or more components. For example, the solvent may be selected from dry toluene, dichloromethane, tetrahydrofuran (THF), methyltetrahydrofuran (methyl-THF), or mixtures thereof. It will be understood that the person skilled in the art will adapt the solvent to the solubility of the used components (a) and (b), in particular of the ligand L.

The step (ii) of incubating the solution at conditions allowing the formation of the copper (I) complex may be performed at any conditions suitible for this purpose. It will be understood that the person skilled in the art will adapt this step to the used components (a) and (b), in particular of the ligand L. In a preferred embodiment, step (ii) is conducted at a temperature in the range of between 80 and 250° C., more preferably at a temperature in the range of between 90 and 200° C., even more preferably at a temperature in the range of between 100 and 150° C., even more preferably at a temperature in the range of between 100 and 120° C., even more preferably at a temperature in the range of between 105 and 115° C., for example at a temperature of approximately 110° C. In a preferred embodiment, step (ii) is conducted for at least one hour, more preferably for at least two hours, even more preferably for at least four hours, even more preferably for at least twelve hours, even more preferably for between 12 and 48 hours, even more preferably for between 20 and 28 hours, even more preferably for between 22 and 26 hours, exemplarily for approximately 24 hours. Accordingly, in a preferred embodiment, step (ii) is conducted at a temperature in the range of between 80 and 250° C. for at least 1 hour. In a more preferred embodiment, step (ii) is conducted at a temperature in the range of between 100 and 150° C. for between 12 and 48 hours. In an even more preferred embodiment, step (ii) is conducted at a temperature in the range of between 105 and 115° C. for between 22 and 26 hours. In an even more preferred embodiment, step (ii) is conducted at a temperature in the range of between 100 and 120° C. for between 20 and 28 hours. Exemplarily, step (ii) is conducted at a temperature of approximately 110° C. for approximately 24 hours. Then, the mixture obtained from step (ii) may be cooled down to room temperature (RT).

As an optional further step (iii), the solvent may be removed. This may be performed by any means such as, e.g., by means of a vacuum. For example, at a laboratory scale, a rotary evaporator or a dissicator may be used for this step. will be understood, that, in particular at an industrial scale, also other means may be used. In this step (iii), a solid residue of the copper (I) complex of the present invention may be obtained.

As an optional further step (iv), a composition comprising the copper (I) complex of the present invention obtainable from any of the above steps is contacted with an anti-solvent. Preferably, a solid residue of the copper (I) complex of the present invention is prepared and dissolved in a suitable solvent. The solvent may be any solvent usable to dissolve the copper (I) complex of the present invention. It will be understood that the solvent may also be a mixture of two or more components. For example, the solvent may be dichloromethane (CH₂Cl₂). It will be understood that the person skilled in the art will adapt the solvent to the solubility of the copper (I) complex of the present invention.

As used throughout the present invention, the term “anti-solvent” may be understood in the broadest sense as any liquid in which the copper (I) complex of the present invention is less soluble. Thus, when the solution comprising the copper (I) complex of the present invention is mixed with the anti-solvent, it may at least partly precipitate.

The anti-solvent may be any liquid suitible for this purpose. It will be understood that the person skilled in the art will adapt the anti-solvent to the solubility of the copper (I) complex of the present invention. For example, the anti-solvent may be diethyl ether (Et₂O). Optionally, the precipitate may also be washed once, or more often by an anti-solvent. Optionally, the copper (I) complex of the present invention may be dried by any means, e.g., by means of filtration, centrifugation, evaporation, etc. For example, the copper (I) complex of the present invention may be dried under vacuum.

As indicated above, the copper (I) complex of the present invention may be used for any purpose and in any composition.

Therefore, the present invention also relates to various materials and devices comprising a copper (I) complex of the present invention and to uses thereof. For example, the present invention refers to the use of a copper (I) complex of the present invention as precursor for organometallic chemistry or monomer in metallo-polymer type of material. The copper (I) complex of the present invention may, for instance, be used as precursor for the production of electronic components, catalysts, for thermal stabilization of engineering thermoplastics or as modifiers of light transmission through the polyolefin films for agriculture. The compounds of the present invention can also be grafted on various structures.

Accordingly, a further aspect of the present invention relates to a method for generating a cubane-like conjugate CC, said method comprising the following steps:
(I) providing, in an inert atmosphere:
   (A) a copper (I) complex of the present invention,
   (B) an unsaturated moiety (B) to be conjugated thereto; and
   (C) a solvent in which components (A) and (B) are dissolved;
(II) incubating the composition of step (I) at conditions allowing the reaction of the unsaturated moiety (B) with the phosphorus atom of the ligand L;
(III) optionally adding polymer monomers to the solution of step (II) and initiating polymerization; and
(IV) optionally removing the solvent.

It will be understood that the definitions and preferred embodiments as laid out in the context of the copper (I) complex of the present invention and the method for preparing such above mutatis mutandis apply to any use and method of use thereof.

The person skilled in the art will understand that the term “cubane-like conjugate” might be understood in the broadest sense as a molecular entity that is obtained from reacting the copper (I) complex of the present invention with an unsaturated moiety (B). Typically but not necessarily, a pi-electron of a double bond of the moiety (B) there by reacts with the copper (I) complex of the present invention, in particular a phosphorous atom thereof. Then, the hydrogen attached to the phosphorous atom may be replaced by a residue of the moiety (B). This may lead to a ligand structure

P(residue of moiety B)(Ar)₂,

wherein Ar and P are defined as laid our herein. It will be understood that the designation of the cubane-like conjugate as “CC” is merely intended for clarification to improve readability. It will be understood that this designation may also be omitted without amending the meaning. It will be understood that the term “cubane-like conjugate” may also be replaced by “cubane-like compound” or simply “compound” without amending the meaning of the chemical entity.

Step (I) of providing the components (A)-(C) may be performed by any means. Preferably, the components (A)-(C) are provided in the (essential) absence of water, in particular in the (essential) absence of water and oxygen. Accordingly, (essentially) water-free solvent is used. The components (A)-(C) may be provided by any means for providing an inert atmosphere such as, e.g., an airproof container. in any type of airproof container. Such airproof container may be a Schlenck tube. Such airproof container may be flame-dried. It will be understood, that, in particular at an industrial scale, also other airproof containers may be used. For providing an inert atmosphere, any protection gas (also : inert gas) may be used. For example a noble gas (e.g., argon) or nitrogen may be used as an inert atmosphere. Preferably, an inert atmosphere may be under argon atmosphere.

The solvent may be any solvent usable to dissolve components (A) and (B), i.e., the copper (I) complex of the present invention and an unsaturated moiety (B) to be conjugated thereto. Preferably, the solvent is (essentially) free of water, in other words, is a dry solvent. It will be understood that the solvent may also be a mixture of two or more components. For example, the solvent may be selected from dry toluene, acetonitrile, dichloromethane, tetrahydrofuran (THF), methyltetrahydrofuran (methyl-THF) or mixtures thereof. It will be understood that the person skilled in the art will adapt the solvent to the solubility of the used components (A) and (B). For example, the solvent may be dry acetonitrile or dichloromethane.

The unsaturated moiety (B) to be conjugated to the copper (I) complex of the present invention may be any unsaturated moiety (B) that is suitable for reacting with the with the phosphorus atom of the ligand L. bound to Cu.

The unsaturated moiety (B) may be a small-molecule compound of a molecular weight of not more than 500 Da or may be a high-molecular weight compound of a molecular weight (MW) of more than 500 Da or may a solid support.

In a preferred embodiment, the unsaturated moiety (B) is a moiety of Formula (C1):

R^{A} HC═CR^{B}R^{C} (C1),

wherein:

the residues R^{A} and R^{B} adjacent to the double bond may be in trans or is cis orientation;

R^{A} to R^{C} are each independently from another selected from hydrogen, unsubstituted or substituted C₁-C₂₀-alkyl, unsubstituted or substituted C₆-C₃₀-aryl, a polymeric residue (with or without a connecting linker), a solid support (with or without a connecting linker), unsubstituted, substituted C₁-C₂₀-alkoxy, and halogen, wherein two residues of formula (C1) may optionally be conjugated with another, in particular when two residues R^{C} are conjugated with another.

In a preferred embodiment, the compounds may be conjugated as follows:

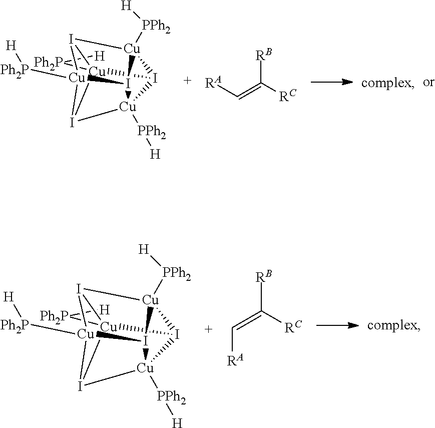

wherein the residues R^{A}, R^{B}, R^{C} and Ph are defined as above. It is understood that this scheme also works with a mixture of two (or more) different unsaturated moities (B) as presented herein. It will be understood that each Ph may independently from another be replaced by any Ar.

As used throughout the present invention, the term “polymeric residue” may be understood in the broadest sense as any chemical entity that comprises three or more consecutive monomeric entities. Preferably, a polymeric residue has a molecular weight (MW) of at least 5 kDa, more preferably of at least 10 kDa, in particular of at least 50 kDa. A polymeric residue may also form part of a solid support such as, e.g, a solid surface or a bead.

As used throughout the present invention, the term “solid support” may be understood in the broadest sense as the surface of any solid such as, e.g, a macroscopic surface (e.g., an essentially planar macroscopic surface or a spherical macroscopic surface), a nanobead or a microbead. Therefore, the present invention is also suitable for the use of functionalizing a solid support. In this case, a solid support bears an immobilized unsaturated moiety or a bifunctional compound that bears at least one functionality binding to the solid support and at least one unsaturated group that binds to the phosphorus of ligand L may be used.

In a preferred embodiment, R^{A} to R^{C} are each independently from another selected from hydrogen, unsubstituted or substituted C₁-C₁₀-alkyl, unsubstituted or substituted C₆-C₁₀-aryl, and a polymeric residue. In a preferred embodiment, R^{A} to R^{C} are each independently from another selected from hydrogen, unsubstituted or substituted C₁-C₄-alkyl, unsubstituted or substituted phenyl, and a polymeric residue (with or without a connecting linker), a solid support (with or without a connecting linker).

In a preferred embodiment, R^{A} is hydrogen, i.e., Formula (C1) is H₂C═CR^{B}R^{C}. In a more preferred embodiment, R^{A} and R^{B} are each hydrogen, i.e., Formula (C1) is H₂C═CHR^{C}, wherein R^{C} is defined as above.

In a preferred embodiment, the unsaturated moiety (B) is a moiety of any of Formulae (C11) or (C12):

R^{A} HC═CR^{B}—CO—R^{C} (C11), or

R^{A} HC═CR^{B}—CO—O—R^{C} (C12),

wherein R^{A} to R^{C} are each independently from another selected from hydrogen, unsubstituted or substituted C₁-C₁₉-alkyl, unsubstituted or substituted C₆-C₂₉-aryl, a polymeric residue (with or without a connecting linker), a solid support (with or without a connecting linker), and halogen.

In a preferred embodiment, such unsaturated moiety (B) of any of Formulae (C11) or (C12) is a (meth)acrylate or a (meth)acrolein derivative AD, wherein preferably

R^{A} is hydrogen or halogen, in particular is hydrogen, and R^{B} is hydrogen, methyl, halogen or halogenated methyl, in particular is hydrogen or methyl. Accordingly, in a preferred embodiment, the unsaturated moiety (B) is a moiety of any of Formulae (C13) to (C16):

H₂C═CH—CO—R^{C} (C13),

H₂C═CH—CO—O—R^{C} (C14),

H₂C═C(CH₃)—CO—R^{C} (C15), or

H₂C═C(CH₃)—CO—O—R^{C} (C16).

In a preferred embodiment, such (meth)acrylate derivative AD compound is selected from the group consisting of acrolein, isopentyl diacrylate, propanediol diacrylate, hexanediol diacrylate, ethanediol dimetacrylate, hexanediol dimetacrylate, ditertbutylphenol acrylate, methyl itaconate, cardanol acrylate, ortho-allyl-phenol acrylate, hex-1-yne acrylate, cyclohexyl metacrylate, furane metacrylate, ethylhexyl acrylate, perfluoroaryl acrylate, tert.-butyl metacrylate, butyl acrylate, butyl metacrylate, ethyl acrylate, ethyl metacrylate, PEG-1 to PEG-20 acrylate (in particular PEG-9 acrylate), hexyl 1,6 diethylene glycol acrylate, thiophene acrylate, methylacrylate, methyl acrylate, and diterbutyl catechol acrylate.

In a preferred embodiment, the compounds may be conjugated as follows:

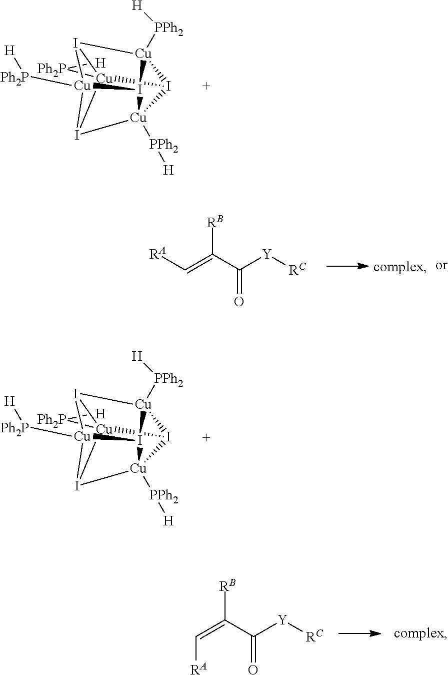

wherein the residues R^{A}, R^{B}, R^{C} and Ph are defined as above and Y absent (i.e., forms a single bond between —CO and R^{C}) or O. It is understood that this scheme also works with a mixture of two (or more) different unsaturated moities (B) as presented herein. It will be understood that each Ph may independently from another be replaced by any Ar. In a preferred embodiment, this step is conducted according to the following scheme:

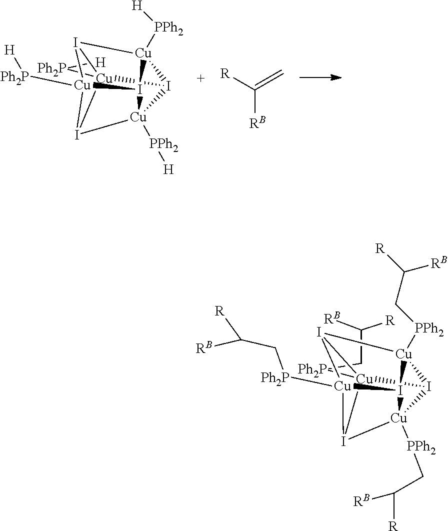

It will be understood that each Ph may independently from another be replaced by any Ar. R^{B} is preferably hydrogen or methyl. Also two different ligands may be used. Thus, in an alternative preferred embodiment, this step is conducted according to the following scheme:

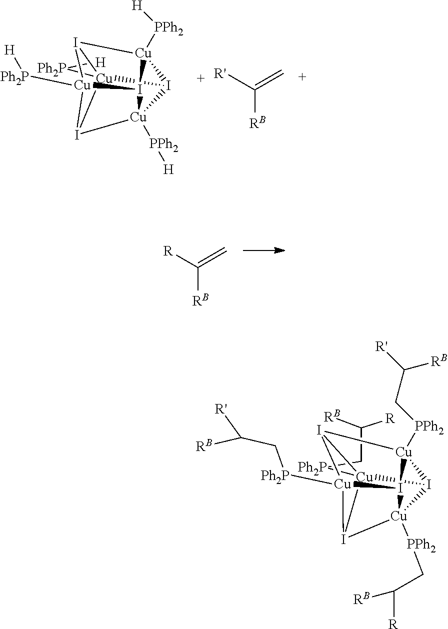

It will be understood that each Ph may independently from another be replaced by any Ar. R^{B} is preferably hydrogen or methyl. Herein, the residues R and R′ may, for example, be independently from another selected from the following the following:

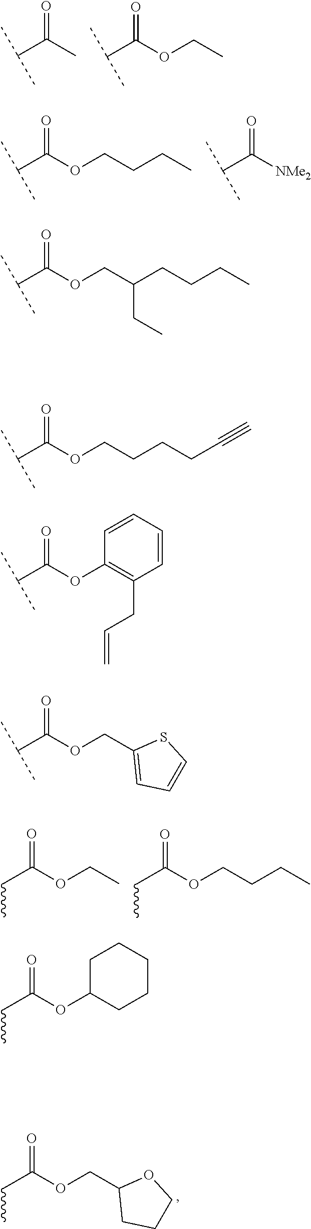

wherein the dashed line indicates the binding site to a —CH═CH₂ moiety (acrylate derivative) and the waved line indicates the binding site to a —C(CH₃)═CH₂ moiety (methacrylate derivative).

Preferably, the reaction is conducted under UV light (e.g., at 455 nm), e.g., obtained by a light-emitting diode (LED) (e.g., LED 455). DCM may be used as solvent. The reaction may be conducted at room temperature for, e.g., 1-4 hours. The unsaturated moiety (B) may be used in a stoichiometric amount around 4 eq or slightly above this level such as 4.2 eq. When a mixture of two different unsaturated moieties (B) are used, these may be each used in approximately half of the stoichiometric amount, i.e., each at around 2 eq, or slightly above, e.g., 2.1 eq.

In an alternative preferred embodiment, the unsaturated moiety (B) is a moiety is a derivative of an ethenyl-substituted aryl residue of formula (C2):

R^{A} HC═CR^{C}Ar (C2),

wherein Ar is unsubstituted or substituted aryl, preferably unsubstituted or substituted C₆-C₁₀-aryl, in particular unsubstituted or substituted C₆-aryl and residues R^{A} and R^{C} are defined as above. In other words, in formula (1), residue R^{B} may be Ar.

Preferably, R^{A} and R^{C} are herein independently selected from hydrogen, methyl, halogen and halogenated methyl, in particular hydrogen or methyl. In a preferred embodiment, the unsaturated moiety (B) is a moiety of any of Formulae (C21) or (C22):

H₂C═CHAr (C21), or

H₂C═C(CH₃)Ar (C22),

wherein Ar is unsubstituted or substituted aryl, preferably unsubstituted or substituted C₆-C₁₀-aryl, in particular unsubstituted or substituted C₆-aryl.

In a preferred embodiment, the unsaturated moiety (B) is a moiety of Formula (C22):

H₂C═CHPh,

wherein Ph is unsubstituted or substituted phenyl such as, e.g., phenyl, a phenylbromide residue (e.g., a para-phenylbromide residue) or divinylbenzene.

In an alternative highly preferred embodiment, the unsaturated moiety (B) is a moiety of Formula (C3):

H₂C═CH—R^{d}-[polymer],

wherein the polymer may be any polymer, and wherein R^{d} is a single bond or any linker structure, in particular a bond or a linker of not more than 20 carbon atoms. Then, the unsaturated moiety (B) may be or form a polyolefine.

In particular, the polymer is a polymer obtained by radical polymerization of double bonds such as, e.g., a polyvinyl, poly(meth)acrylate, polystyrene, a polymer of styrene derivatives, polyvinyl chloride, polyvinyl acetate, a polyvinyl alcohol, polyacrylonitrile, a polyolefin, polybutadiene, or a blend of two or more thereof. Linkage to the polymer may be achieved by means of a divinyl compound such as, e.g., divinylbenzene.

In an alternative highly preferred embodiment, the unsaturated moiety (B) is a moiety of Formula (C4):

H₂C═CH—R^{d}-[solid support],

wherein the solid support may be any polymer, and wherein R^{d} is a single bond or any linker structure, in particular a bond or a linker of not more than 20 carbon atoms.

The step (II) of incubating the composition of step (I) at conditions allowing the reaction of the unsaturated moiety (B) with the phosphorus atom of the ligand L may be performed at any conditions suitible for this purpose. It will be understood that the person skilled in the art will adapt this step to the used components (A) and (B). In this step, the hydrogen atom bound to the phosphorus of ligand L is substituted (i.e., replaced) by the respective reaction product of the unbound moiety (B), whereby, typically, a double bound may be transferred into a single bond. In other words, this reaction is an addition of the ligand L to the unsaturated bond of the unsaturated moiety (B).

In the case, of mono unsaturated moiety (such as C1), this step (II) may include a reaction of hydrophosphination between (A) and, for example, four equivalents of (B), wherein B may, optionally, be a single type or a mixture of different monosaturated moities. Optionally, this step (II) may also include a polymerization reaction when the unsaturated molecule B contains two or more unsaturated moieties.

In a preferred embodiment, the unsaturated moiety (B) is added in approximately stoichiometrically to the phosphorus atoms. Therefore, preferably, the ratio between unsaturated moiety (B) and copper (I) complex (A) is preferably in the range of (B) : (A) of from 20:1 to 1:1, more preferably of from 10:1 to 2:1, even more preferably of from 6:1 to 3:1, in particular approximately 4:1.

In a preferred embodiment, step (II) is conducted at a temperature in the range of between 50 and 150° C., more preferably at a temperature in the range of between 55 and 100° C., even more preferably at a temperature in the range of between 58 and 90° C., even more preferably at a temperature in the range of between 60 and 80° C., even more preferably at a temperature in the range of between 65 and 75° C., for example at a temperature of approximately 70° C. In a preferred embodiment, step (II) is conducted for at least 30 minutes, more preferably one hour, even more preferably for at least two hours, even more preferably for at least three hours, even more preferably for between three and 24 hours, even more preferably for between four and twelve hours, even more preferably for between five and ten hours, exemplarily for approximately seven hours. Accordingly, in a preferred embodiment, step (II) is conducted at a temperature in the range of between 50 and 150° C. for at least 30 minutes. In a more preferred embodiment, step (II) is conducted at a temperature in the range of between 55 and 100° C. for between four and ten hours. In an even more preferred embodiment, step (II) is conducted at a temperature in the range of between 60 and 80° C. for between five and ten hours. Exemplarily, step (II) is conducted at a temperature of approximately 70° C. for approximately seven hours. Then, the mixture obtained from step (II) may be cooled down to room temperature (RT).

As an optional further step, the solvent may be removed. This may be performed by any means such as, e.g., by means of a vacuum. For example, at a laboratory scale, a rotary evaporator or a dissicator may be used for this step. will be understood, that, in particular at an industrial scale, also other means may be used. In this step, a solid residue of the cubane-like conjugate CC of the present invention may be obtained.

As an optional further step (III), polymer monomers may be added to the solution of step (II) and polymerization may be initiated by any means. As laid out above, any monomer may be used. Preferably, monomers that are suitable for radical polymerization of double bonds such as, e.g., a vinyl, (methyl)acrylate, styrene, styrene derivatives, vinyl chloride, vinyl acetate, vinyl alcohol, acrylonitrile, olefin, butadiene monomers or mixtures of two or more thereof may be used. For example, styrene monomers may be polymerized.

In a preferred embodiment, the unsaturated moiety (B) used in step (II) is as described above, e.g., a divinyl compound such as, e.g., divinylbenzene. Such unsaturated moiety (B) may be well combined with styrenes and/or other vinyl monomers.

As an optional further step, the solvent may be removed. This may be performed by any means such as, e.g., by means of a vacuum. For example, at a laboratory scale, a rotary evaporator or a dissicator may be used for this step. will be understood, that, in particular at an industrial scale, also other means may be used. In this step, a solid residue of the cubane-like conjugate CC of the present invention may be obtained.

It will be understood that the cubane-like conjugate CC may also be formed on a surface. Then, a surface is an unsaturated moiety (B). The copper (I) complex moiety of the present invention may be immobilized by means of the above method.

A cubane-like conjugate CC obtainable from the above method bears special properties. Therefore, a further aspect of the present invention relates to a cubane-like conjugate CC obtainable from the above method.

A still further aspect of the present invention relates to a cubane-like conjugate CC comprising at least one copper (I) complex moiety of Formula (A)

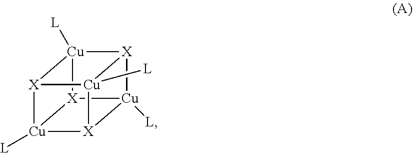

wherein:

each Cu is copper (I);

each X is independently from each other halogen;

each L is independently from each other an optionally substituted diarylphosphine residue of Formula (A1):

PRAr₂ (A1),

wherein:

P is phosphorus;

R is hydrogen or —R^{a}—R^{b};

Ar is defined as above;

R^{a} is an unsubstituted or substituted C₁-C₂₀-alkylene residue; and

R^{b} is a polymeric residue, a C₂-C₂₀-(hetero)aromatic residue, or a C₁-C₂₀-alkoxy residue, wherein each hydrogen may optionally be substituted by an halogen or deuterium,

wherein the phosphorus is bound to Cu;

wherein said copper (I) complex has a neutral net charge, and

wherein in at least one ligand L residue R is —R^{a}—R^{b}.

The above cubane-like conjugate CC is optionally obtainable from a method of the present invention.

It will be understood that the definitions and preferred embodiments as laid out in the context of the copper (I) complex of the present invention and any of the methods above mutatis mutandis apply to the cubane-like conjugate CC.

In a preferred embodiment, R^{a} is an unsubstituted or substituted C₁-C₁₀-alkylene residue, more preferably an unsubstituted or substituted C₂-C₄-alkylene residue, more preferably an unsubstituted or substituted ethylene residue, in particular an unsubstituted ethylene residue.

In a preferred embodiment, the cubane-like conjugate CC is such according to Formula (A) as depicted above, wherein:

each X is independently from each other halogen, preferably each iodine;

each L is independently from each other an optionally substituted diarylphosphine residue of Formula (A2):

PRPh₂ (A2),

wherein:

P is phosphorus;

R is hydrogen or —R^{a}—R^{b};

each Ph is independently from another an unsubstituted or substituted phenyl residue as defined above;

R^{a} is an unsubstituted or substituted C₁-C₁₀-alkylene residue; and R^{b} is a polymeric residue, a C₆-C₁₀-aromatic residue, wherein each hydrogen may optionally be substituted by an halogen or deuterium,

wherein the phosphorus is bound to Cu;

wherein said copper (I) complex has a neutral net charge, and

wherein in at least one ligand L residue R is —R^{a}—R^{b}.

In a more preferred embodiment, the cubane-like conjugate CC is such according to Formula (A) as depicted above, wherein:

each X is independently from each other halogen, preferably each iodine;

each L is independently from each other an optionally substituted diarylphosphine residue of Formula (A2):

PRPh₂ (A2),

wherein:

P is phosphorus;

R is hydrogen or —R^{a}—R^{b};

each Ph is an unsubstituted phenyl residue;

R^{a} is an unsubstituted or substituted C₂-C₄-alkylene residue; and

R^{b} is a polymeric residue or a phenyl residue, wherein each hydrogen may optionally be substituted by an halogen or deuterium,

wherein the phosphorus is bound to Cu;

wherein said copper (I) complex has a neutral net charge, and

wherein in at least one ligand L residue R is —R^{a}—R^{b}.

In a highly preferred embodiment, the cubane-like conjugate CC is such according to Formula (A) as depicted above, wherein:

each X is each iodine;

each L is independently from each other an optionally substituted diarylphosphine residue of Formula (A2):

PRPh₂ (A2),

wherein:

P is phosphorus;

R is hydrogen or —R^{a}—R^{b};

each Ph is an unsubstituted phenyl residue;

R^{a} is an unsubstituted or substituted ethylene residue; and

R^{b} is a polymeric residue or a phenyl residue, wherein each hydrogen may optionally be substituted by an halogen or deuterium,

wherein the phosphorus is bound to Cu;

wherein said copper (I) complex has a neutral net charge, and

wherein in at least one ligand L residue R is —R^{a}—R^{b}.

In a highly preferred embodiment, in at least two ligands L, residue R is —R^{a}—R^{b}. In a highly preferred embodiment, in at least three ligands L, residue R is —R^{a}—R^{b}. In a most preferred embodiment, all ligands L are each residues R ═—R^{a}—R^{b}.

Examples of a cubane-like conjugate CC of the present invention are the following:

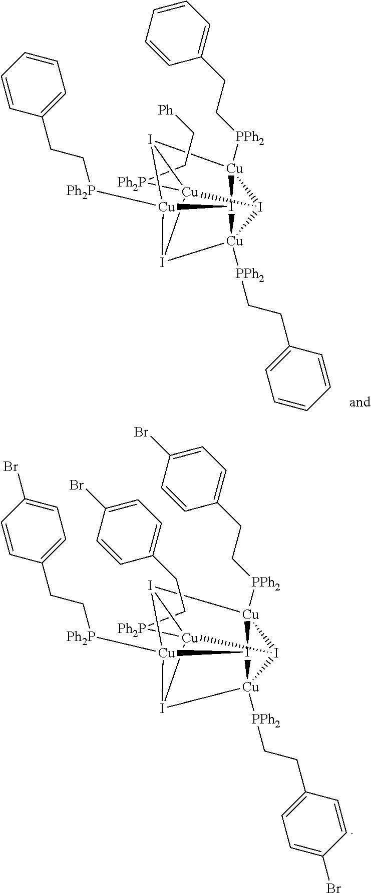

A copper (I) complex or a cubane-like conjugate CC of the present invention may be used for any purpose. A copper (I) complex or a cubane-like conjugate CC of the present invention may, for instance, be used for the production of an opto-electronic device.

Accordingly, a further aspect of the present invention relates to an opto-electronic device containing a copper (I) complex of or a cubane-like conjugate CC of the present invention.

It will be understood that the definitions and preferred embodiments as laid out in the context of the copper (I) complex and the cubane-like conjugate CC of the present invention and any of the methods above mutatis mutandis apply to the opto-electronic device.

An opto-electronic device may be any opto-electronic device known in the art. Ina preferred embodiment, the opto-electronic device is selected from the group consisting of organic light-emitting diodes, organic solar cells, electrographic photoreceptors, organic dye lasers, organic transistors, photoelectric converters, and organic photodetectors.

Also any further uses of the compound are embraced by the present invention. A further aspect of the present invention relates to the use of a copper (I) complex of the present invention or a cubane-like conjugate CC of any of the present invention for thermal stabilization of a thermoplastic molding mass.

Such thermoplastic molding mass may be any thermoplast such as, e.g., an (engineered) thermoplastic matrix.

A further aspect of the present invention relates to the use of a copper (I) complex of the present invention or a cubane-like conjugate CC of the present invention for modifying of light transmission in a material.

In this context, the material in which light transparency can be altered may be any material. Preferably, the material is transparent or at least partly translucent for visible light in the wavelength range of from 400 to 800 nm. Preferably, et material is a polymer material. Such polymer material may be thermoplastic molding mass. For example, such polymer material may be a polyolefin such as., e.g., a polyolefin film. The polymer material may be a polymer film, in particular a polymer film intended to be subjected to UV light (e.g., daylight, sun light) such as, e.g., a (polyolefin) film for agricultural use.

The Figures and Examples and claims are intended to illustrate the present invention.

### BRIEF DESCRIPTION OF THE FIGURES

FIG. 1 shows the three-dimensional structure of a copper (I) complex of the present invention. In the depicted example, the copper (I) complex is based on a cubane-like structure of CuI bound to four hydrogenodiphenylphosphine ligands.

FIG. 2 shows the three-dimensional structure of a copper (I) complex of the present invention, wherein the atoms except the hydrogen atoms are highlighted.

In the depicted example, the copper (I) complex is based on a cubane-like structure of CuI bound to four hydrogenodiphenylphosphine ligands.

### EXAMPLES

Synthesis of a copper (I) complex of the present invention (CuI-diphenylphosphine complex having cubane-like structure):

Copper(I) Iodide, diphenylphosphine (also: hydrogenodiphenylphosphine) and dry toluene (or dry (methyl)tetrahydrofurane) were placed in a flame-dried Schlenck tube under argon. The solution was heated at 110° C. during 24 hours. Then the mixture was cooled down to room temperature (RT) and the solvent was removed under vacuum. The solid residue was dissolved in dichloromethane (CH₂O1₂) and the solution was poured into diethyl ether (Et₂O). The copper (I) complex precipitates directly and was filtrated and washed several times with Et₂O. The product was dried under vacuum.

It was further found that other solvents can be used instead of toluene such as, e.g., dichloromethane or tetrahydrofuran (THF) depending of the solubility of phosphines.

The following copper (I) complex was obtained:

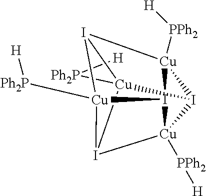

¹H NMR (500 MHz, CDCl₃): 5.82 (d, J=315.6 Hz, 4 H), 7.18 (m, 16 H), 7.26 (m, 8 H), 7.49 (m, 16 H) ppm.

¹³C NMR (126 MHz, CDCl₃): δ128.57(d, J=9 Hz), 129.59, 130.32(d, J=29 Hz), 134.1(d, J=12.4 Hz) ppm.

³¹P {¹H} NMR (203 MHz, CDCl₃): δ-39 (br) ppm.

Anal. Calcd for C₆₄H₆₈Cu₄I₄O₄P₄: C, 38.26; H, 2.94. Found: C, 36.49; H, 2.82.

IR (neat) v=2975, 1476, 1437, 1089, 887, 819, 725, 686 cm⁻¹

ATG: 5% per mass lost at 257° C.

Determining the Structure:

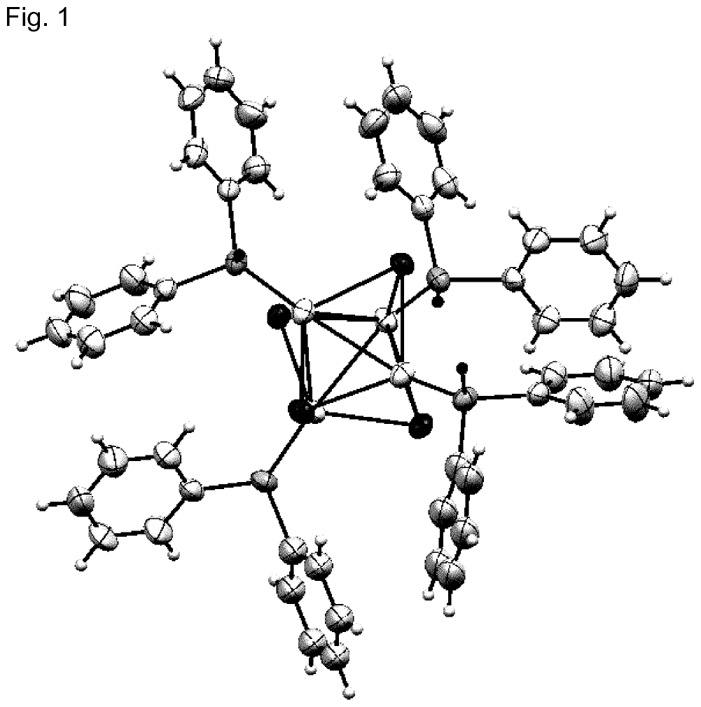

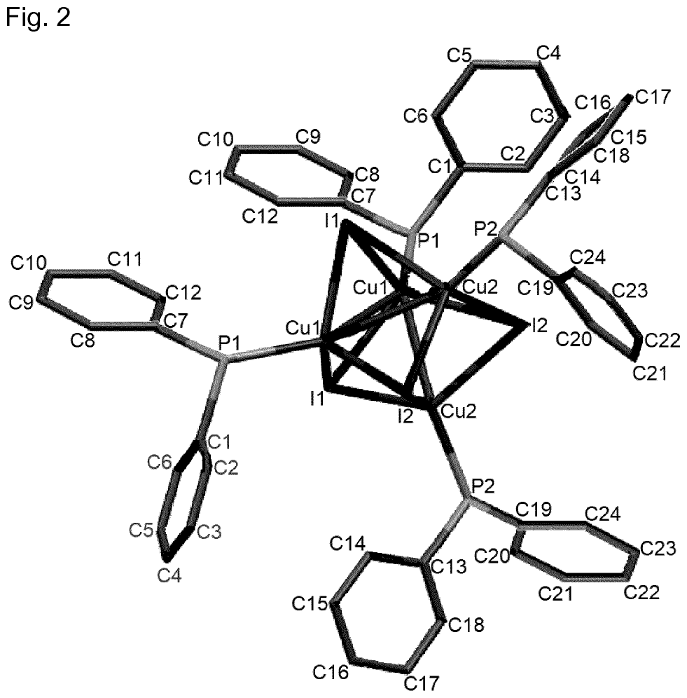

The three-dimensional (3D) (crystal) structure was determined by means of NMR. The results are depicted in FIGS. 1 and 2. The following distances and angles have been determined. The numbers correspond to those depicted in FIG. 2.

TABLE 1
Distances determined
for the Cul cubane-
like core structure:

| No. | Objects | | Length |
|---|---|---|---|
| 1 | Cu1 | Cu2 | 2.8735(8) |
| 2 | Cu1 | I2 | 2.6799(7) |
| 3 | Cu1 | I1 | 2.6826(8) |
| 4 | Cu1 | I1 | 2.6759(6) |
| 5 | Cu1 | P1 | 2.251(1) |
| 6 | Cu1 | Cu2 | 2.8132(9) |
| 7 | Cu1 | Cu1 | 2.8158(7) |
| 8 | Cu1 | Cu2 | 2.8735(8) |
| 9 | Cu1 | I2 | 2.6799(7) |
| 10 | Cu1 | I1 | 2.6826(8) |
| 11 | Cu1 | I1 | 2.6759(6) |
| 12 | Cu1 | P1 | 2.251(1) |
| 13 | Cu1 | Cu2 | 2.8132(9) |
| 14 | Cu2 | I2 | 2.6807(6) |
| 15 | Cu2 | I2 | 2.6901(8) |
| 16 | Cu2 | I1 | 2.6793(7) |
| 17 | Cu2 | P2 | 2.248(1) |
| 18 | Cu2 | I2 | 2.6807(6) |
| 19 | Cu2 | P2 | 2.248(1) |
| 20 | Cu2 | I2 | 2.6901(8) |
| 21 | Cu2 | I1 | 2.6793(7) |
| 22 | Cu2 | Cu2 | 3.0539(9) |

TABLE 2
Angles determined
for the Cul cubane-
like core structure:

| No. | compared objects | | | Angle |
|---|---|---|---|---|
| 1 | Cu1 | Cu1 | Cu2 | 61.39(2) |
| 2 | Cu1 | Cu1 | I1 | 58.18(2) |
| 3 | Cu1 | Cu2 | I1 | 57.49(2) |
| 4 | Cu1 | Cu2 | I2 | 57.57(2) |
| 5 | Cu1 | Cu2 | Cu1 | 59.35(2) |
| 6 | Cu1 | Cu2 | I2 | 103.39(2) |
| 7 | Cu1 | Cu2 | I2 | 58.23(2) |
| 8 | Cu1 | I1 | Cu2 | 64.90(2) |
| 9 | Cu1 | I1 | Cu1 | 63.40(2) |
| 10 | Cu1 | I2 | Cu2 | 64.83(2) |
| 11 | Cu1 | I2 | Cu2 | 63.19(2) |
| 12 | Cu1 | Cu1 | Cu2 | 61.39(2) |
| 13 | Cu1 | Cu1 | I1 | 58.18(2) |
| 14 | Cu1 | Cu1 | P1 | 149.68(4) |
| 15 | Cu1 | Cu1 | Cu2 | 59.26(2) |
| 16 | Cu1 | Cu1 | I1 | 58.41(2) |
| 17 | Cu1 | Cu1 | I2 | 105.23(2) |
| 18 | Cu1 | Cu2 | I2 | 58.23(2) |
| 19 | Cu1 | Cu2 | P2 | 144.69(4) |
| 20 | Cu1 | Cu2 | Cu1 | 59.35(2) |
| 21 | Cu1 | Cu2 | I1 | 58.41(2) |
| 22 | Cu1 | Cu2 | I2 | 105.27(2) |
| 23 | Cu1 | Cu2 | I1 | 57.49(2) |
| 24 | Cu1 | Cu2 | I2 | 57.57(2) |
| 25 | Cu1 | I1 | Cu1 | 63.40(2) |
| 26 | Cu1 | I1 | Cu2 | 63.29(2) |
| 27 | Cu1 | I1 | Cu2 | 64.90(2) |
| 28 | Cu1 | I2 | Cu2 | 64.83(2) |
| 29 | Cu2 | Cu1 | I1 | 57.61(2) |
| 30 | Cu2 | Cu1 | I2 | 57.60(2) |
| 31 | Cu2 | Cu1 | Cu1 | 59.26(2) |
| 32 | Cu2 | Cu1 | Cu2 | 64.95(2) |
| 33 | Cu2 | Cu1 | I1 | 109.12(2) |
| 34 | Cu2 | Cu1 | I1 | 58.30(2) |
| 35 | Cu2 | I1 | Cu1 | 63.29(2) |
| 36 | Cu2 | I2 | Cu2 | 69.30(2) |
| 37 | Cu2 | Cu1 | I1 | 58.30(2) |
| 38 | Cu2 | Cu1 | P1 | 138.04(4) |
| 39 | Cu2 | Cu1 | Cu2 | 64.95(2) |
| 40 | Cu2 | Cu1 | I1 | 111.13(2) |
| 41 | Cu2 | Cu1 | I2 | 58.59(2) |
| 42 | Cu2 | Cu1 | I1 | 57.61(2) |
| 43 | Cu2 | Cu1 | I2 | 57.60(2) |
| 44 | Cu2 | I2 | Cu1 | 63.19(2) |
| 45 | Cu2 | I2 | Cu2 | 69.30(2) |
| 46 | I1 | Cu1 | I2 | 110.19(2) |
| 47 | I1 | Cu1 | Cu1 | 58.41(2) |
| 48 | I1 | Cu1 | Cu2 | 111.13(2) |
| 49 | I1 | Cu1 | I1 | 109.18(2) |
| 50 | I1 | Cu2 | I2 | 110.06(2) |
| 51 | I1 | Cu2 | Cu1 | 58.41(2) |
| 52 | I1 | Cu2 | I2 | 113.46(2) |
| 53 | I1 | Cu1 | P1 | 107.82(4) |
| 54 | I1 | Cu1 | Cu2 | 109.12(2) |
| 55 | I1 | Cu1 | I1 | 109.18(2) |
| 56 | I1 | Cu1 | I2 | 113.69(2) |
| 57 | I1 | Cu1 | I2 | 110.19(2) |
| 58 | I1 | Cu2 | I2 | 110.06(2) |
| 59 | I2 | Cu1 | Cu1 | 105.23(2) |
| 60 | I2 | Cu1 | Cu2 | 58.59(2) |
| 61 | I2 | Cu1 | I1 | 113.69(2) |
| 62 | I2 | Cu2 | Cu1 | 105.27(2) |
| 63 | I2 | Cu2 | I2 | 103.83(2) |
| 64 | I2 | Cu2 | P2 | 111.87(4) |
| 65 | I2 | Cu2 | Cu1 | 103.39(2) |
| 66 | I2 | Cu2 | I1 | 113.46(2) |
| 67 | I2 | Cu2 | I2 | 103.83(2) |
| 68 | P1 | Cu1 | Cu2 | 143.02(4) |
| 69 | P1 | Cu1 | I1 | 110.81(4) |
| 70 | P1 | Cu1 | I2 | 105.08(4) |
| 71 | P1 | Cu1 | Cu1 | 149.68(4) |
| 72 | P1 | Cu1 | Cu2 | 138.04(4) |
| 73 | P1 | Cu1 | I1 | 107.82(4) |
| 74 | P1 | Cu1 | Cu2 | 143.02(4) |
| 75 | P1 | Cu1 | I1 | 110.81(4) |
| 76 | P1 | Cu1 | I2 | 105.08(4) |
| 77 | P2 | Cu2 | Cu1 | 144.68(4) |
| 78 | P2 | Cu2 | I1 | 107.56(4) |
| 79 | P2 | Cu2 | I2 | 110.04(4) |
| 80 | P2 | Cu2 | Cu1 | 144.69(4) |
| 81 | P2 | Cu2 | I2 | 111.87(4) |
| 82 | P2 | Cu2 | Cu1 | 144.68(4) |
| 83 | P2 | Cu2 | I1 | 107.56(4) |
| 84 | P2 | Cu2 | I2 | 110.04(4) |

TABLE 3
Angles determined for
the copper (I) complex
structure:

| No. | Atoms | | | Angle |
|---|---|---|---|---|
| 1 | C1 | C2 | H2 | 120.5 |
| 2 | C1 | C2 | C3 | 119.2(5) |
| 3 | C1 | C6 | C5 | 120.2(6) |
| 4 | C1 | C6 | H6 | 119.9 |
| 5 | C1 | P1 | C7 | 103.5(2) |
| 6 | C1 | P1 | Cu1 | 116.9(2) |
| 7 | C1 | P1 | H1P | 98(2) |
| 8 | C1 | C2 | H2 | 120.5 |
| 9 | C1 | C2 | C3 | 119.2(5) |
| 10 | C1 | C6 | C5 | 120.2(6) |
| 11 | C1 | C6 | H6 | 119.9 |
| 12 | C1 | P1 | C7 | 103.5(2) |
| 13 | C1 | P1 | Cu1 | 116.9(2) |
| 14 | C1 | P1 | H1P | 98(2) |
| 15 | C10 | C11 | H11 | 120.2 |
| 16 | C10 | C11 | C12 | 119.7(7) |
| 17 | C10 | C11 | H11 | 120.2 |
| 18 | C10 | C11 | C12 | 119.7(7) |
| 19 | C11 | C12 | H12 | 119.2 |
| 20 | C11 | C12 | H12 | 119.2 |
| 21 | C12 | C7 | P1 | 119.7(4) |
| 22 | C12 | C7 | P1 | 119.7(4) |
| 23 | C13 | C14 | H14 | 119.3 |
| 24 | C13 | C14 | C15 | 121.2(6) |
| 25 | C13 | C18 | C17 | 121.7(6) |
| 26 | C13 | C18 | H18 | 119.2 |
| 27 | C13 | P2 | C19 | 103.5(3) |
| 28 | C13 | P2 | Cu2 | 118.4(2) |
| 29 | C13 | P2 | H2P | 103(2) |
| 30 | C13 | C14 | H14 | 119.3 |
| 31 | C13 | C14 | C15 | 121.2(6) |
| 32 | C13 | C18 | C17 | 121.7(6) |
| 33 | C13 | C18 | H18 | 119.2 |
| 34 | C13 | P2 | C19 | 103.5(3) |
| 35 | C13 | P2 | Cu2 | 118.4(2) |
| 36 | C13 | P2 | H2P | 103(2) |
| 37 | C14 | C13 | C18 | 117.5(5) |
| 38 | C14 | C13 | P2 | 120.0(4) |
| 39 | C14 | C15 | H15 | 120.0 |
| 40 | C14 | C15 | C16 | 120.0(7) |
| 41 | C14 | C13 | C18 | 117.5(5) |
| 42 | C14 | C13 | P2 | 120.0(4) |
| 43 | C14 | C15 | H15 | 120.0 |
| 44 | C14 | C15 | C16 | 120.0(7) |
| 45 | C15 | C16 | H16 | 120.1 |
| 46 | C15 | C16 | C17 | 119.9(7) |
| 47 | C15 | C16 | H16 | 120.1 |
| 48 | C15 | C16 | C17 | 119.9(7) |
| 49 | C16 | C17 | H17 | 120.2 |
| 50 | C16 | C17 | C18 | 119.6(7) |
| 51 | C16 | C17 | H17 | 120.2 |
| 52 | C16 | C17 | C18 | 119.6(7) |
| 53 | C17 | C18 | H18 | 119.1 |
| 54 | C17 | C18 | H18 | 119.1 |
| 55 | C18 | C13 | P2 | 122.5(4) |
| 56 | C18 | C13 | P2 | 122.5(4) |
| 57 | C19 | C20 | H20 | 119.8 |
| 58 | C19 | C20 | C21 | 120.4(7) |
| 59 | C19 | C24 | C23 | 119.2(7) |
| 60 | C19 | C24 | H24 | 120.4 |
| 61 | C19 | P2 | Cu2 | 117.2(2) |
| 62 | C19 | P2 | H2P | 98(2) |
| 63 | C19 | C20 | H20 | 119.8 |
| 64 | C19 | C20 | C21 | 120.4(7) |
| 65 | C19 | C24 | C23 | 119.2(7) |
| 66 | C19 | C24 | H24 | 120.4 |
| 67 | C19 | P2 | Cu2 | 117.2(2) |
| 68 | C19 | P2 | H2P | 98(2) |
| 69 | C2 | C1 | C6 | 120.5(5) |
| 70 | C2 | C1 | P1 | 119.6(4) |
| 71 | C2 | C3 | H3 | 119.7 |
| 72 | C2 | C3 | C4 | 120.8(6) |
| 73 | C2 | C1 | C6 | 120.5(5) |
| 74 | C2 | C1 | P1 | 119.6(4) |
| 75 | C2 | C3 | H3 | 119.7 |
| 76 | C2 | C3 | C4 | 120.8(6) |
| 77 | C20 | C19 | C24 | 117.9(7) |
| 78 | C20 | C19 | P2 | 123.3(6) |
| 79 | C20 | C21 | H21 | 119.8 |
| 80 | C20 | C21 | C22 | 120.3(7) |
| 81 | C20 | C19 | C24 | 117.9(7) |
| 82 | C20 | C19 | P2 | 123.3(6) |
| 83 | C20 | C21 | H21 | 119.8 |
| 84 | C20 | C21 | C22 | 120.3(7) |
| 85 | C21 | C22 | H22 | 119.5 |
| 86 | C21 | C22 | C23 | 120.9(7) |
| 87 | C21 | C22 | H22 | 119.5 |
| 88 | C21 | C22 | C23 | 120.9(7) |
| 89 | C22 | C23 | H23 | 119.2 |
| 90 | C22 | C23 | C24 | 121.3(7) |
| 91 | C22 | C23 | H23 | 119.2 |
| 92 | C22 | C23 | C24 | 121.3(7) |
| 93 | C23 | C24 | H24 | 120.4 |
| 94 | C23 | C24 | H24 | 120.4 |
| 95 | C24 | C19 | P2 | 118.8(6) |
| 96 | C24 | C19 | P2 | 118.8(6) |
| 97 | C3 | C4 | H4 | 120.2 |
| 98 | C3 | C4 | C5 | 119.6(6) |
| 99 | C3 | C4 | H4 | 120.2 |
| 100 | C3 | C4 | C5 | 119.6(6) |
| 101 | C4 | C5 | H5 | 120.1 |
| 102 | C4 | C5 | C6 | 119.7(6) |
| 103 | C4 | C5 | H5 | 120.1 |
| 104 | C4 | C5 | C6 | 119.7(6) |
| 105 | C5 | C6 | H6 | 119.9 |
| 106 | C5 | C6 | H6 | 119.9 |
| 107 | C6 | C1 | P1 | 119.9(4) |
| 108 | C6 | C1 | P1 | 119.9(4) |
| 109 | C7 | C8 | H8 | 119.9 |
| 110 | C7 | C8 | C9 | 120.1(5) |
| 111 | C7 | C12 | C11 | 121.4(6) |
| 112 | C7 | C12 | H12 | 119.4 |
| 113 | C7 | P1 | Cu1 | 117.7(2) |
| 114 | C7 | P1 | H1P | 98(2) |
| 115 | C7 | C8 | H8 | 119.9 |
| 116 | C7 | C8 | C9 | 120.1(5) |
| 117 | C7 | C12 | C11 | 121.4(6) |
| 118 | C7 | C12 | H12 | 119.4 |
| 119 | C7 | P1 | Cu1 | 117.7(2) |
| 120 | C7 | P1 | H1P | 98(2) |
| 121 | C8 | C7 | C12 | 118.1(5) |
| 122 | C8 | C7 | P1 | 122.2(4) |
| 123 | C8 | C9 | H9 | 119.7 |
| 124 | C8 | C9 | C10 | 120.6(6) |
| 125 | C8 | C7 | C12 | 118.1(5) |
| 126 | C8 | C7 | P1 | 122.2(4) |
| 127 | C8 | C9 | H9 | 119.7 |
| 128 | C8 | C9 | C10 | 120.6(6) |
| 129 | C9 | C10 | H10 | 119.9 |
| 130 | C9 | C10 | C11 | 120.2(7) |
| 131 | C9 | C10 | H10 | 119.9 |
| 132 | C9 | C10 | C11 | 120.2(7) |
| 133 | Cu1 | P1 | H1P | 119(2) |
| 134 | Cu1 | Cu1 | Cu2 | 61.39(2) |
| 135 | Cu1 | Cu1 | I1 | 58.18(2) |
| 136 | Cu1 | Cu2 | I1 | 57.49(2) |
| 137 | Cu1 | Cu2 | I2 | 57.57(2) |
| 138 | Cu1 | Cu2 | Cu1 | 59.35(2) |
| 139 | Cu1 | Cu2 | I2 | 103.39(2) |
| 140 | Cu1 | Cu2 | I2 | 58.23(2) |
| 141 | Cu1 | I1 | Cu2 | 64.90(2) |
| 142 | Cu1 | I1 | Cu1 | 63.40(2) |
| 143 | Cu1 | I2 | Cu2 | 64.83(2) |
| 144 | Cu1 | I2 | Cu2 | 63.19(2) |
| 145 | Cu1 | P1 | H1P | 119(2) |
| 146 | Cu1 | Cu1 | Cu2 | 61.39(2) |
| 147 | Cu1 | Cu1 | I1 | 58.18(2) |
| 148 | Cu1 | Cu1 | P1 | 149.68(4) |
| 149 | Cu1 | Cu1 | Cu2 | 59.26(2) |
| 150 | Cu1 | Cu1 | I1 | 58.41(2) |
| 151 | Cu1 | Cu1 | I2 | 105.23(2) |
| 152 | Cu1 | Cu2 | I2 | 58.23(2) |
| 153 | Cu1 | Cu2 | P2 | 144.69(4) |
| 154 | Cu1 | Cu2 | Cu1 | 59.35(2) |
| 155 | Cu1 | Cu2 | I1 | 58.41(2) |
| 156 | Cu1 | Cu2 | I2 | 105.27(2) |
| 157 | Cu1 | Cu2 | I1 | 57.49(2) |
| 158 | Cu1 | Cu2 | I2 | 57.57(2) |
| 159 | Cu1 | I1 | Cu1 | 63.40(2) |
| 160 | Cu1 | I1 | Cu2 | 63.29(2) |
| 161 | Cu1 | I1 | Cu2 | 64.90(2) |
| 162 | Cu1 | I2 | Cu2 | 64.83(2) |
| 163 | Cu2 | P2 | H2P | 114(2) |
| 164 | Cu2 | Cu1 | I1 | 57.61(2) |
| 165 | Cu2 | Cu1 | I2 | 57.60(2) |
| 166 | Cu2 | Cu1 | Cu1 | 59.26(2) |
| 167 | Cu2 | Cu1 | Cu2 | 64.95(2) |
| 168 | Cu2 | Cu1 | I1 | 109.12(2) |
| 169 | Cu2 | Cu1 | I1 | 58.30(2) |
| 170 | Cu2 | I1 | Cu1 | 63.29(2) |
| 171 | Cu2 | I2 | Cu2 | 69.30(2) |
| 172 | Cu2 | P2 | H2P | 114(2) |
| 173 | Cu2 | Cu1 | I1 | 58.30(2) |
| 174 | Cu2 | Cu1 | P1 | 138.04(4) |
| 175 | Cu2 | Cu1 | Cu2 | 64.95(2) |
| 176 | Cu2 | Cu1 | I1 | 111.13(2) |
| 177 | Cu2 | Cu1 | I2 | 58.59(2) |
| 178 | Cu2 | Cu1 | I1 | 57.61(2) |
| 179 | Cu2 | Cu1 | I2 | 57.60(2) |
| 180 | Cu2 | I2 | Cu1 | 63.19(2) |
| 181 | Cu2 | I2 | Cu2 | 69.30(2) |
| 182 | H10 | C10 | C11 | 119.9 |
| 183 | H10 | C10 | C11 | 119.9 |
| 184 | H11 | C11 | C12 | 120.1 |
| 185 | H11 | C11 | C12 | 120.1 |
| 186 | H14 | C14 | C15 | 119.5 |
| 187 | H14 | C14 | C15 | 119.5 |
| 188 | H15 | C15 | C16 | 120.0 |
| 189 | H15 | C15 | C16 | 120.0 |
| 190 | H16 | C16 | C17 | 119.9 |
| 191 | H16 | C16 | C17 | 119.9 |
| 192 | H17 | C17 | C18 | 120.2 |
| 193 | H17 | C17 | C18 | 120.2 |
| 194 | H2 | C2 | C3 | 120.3 |
| 195 | H2 | C2 | C3 | 120.3 |
| 196 | H20 | C20 | C21 | 119.8 |
| 197 | H20 | C20 | C21 | 119.8 |
| 198 | H21 | C21 | C22 | 119.9 |
| 199 | H21 | C21 | C22 | 119.9 |
| 200 | H22 | C22 | C23 | 119.6 |
| 201 | H22 | C22 | C23 | 119.6 |
| 202 | H23 | C23 | C24 | 119.5 |
| 203 | H23 | C23 | C24 | 119.5 |
| 204 | H3 | C3 | C24 | 119.5 |
| 205 | H3 | C3 | C24 | 119.5 |
| 206 | H4 | C4 | C5 | 120.3 |
| 207 | H4 | C4 | C5 | 120.3 |
| 208 | H5 | C5 | C6 | 120.1 |
| 209 | H5 | C5 | C6 | 120.1 |
| 210 | H8 | C8 | C9 | 120.0 |
| 211 | H8 | C8 | C9 | 120.0 |
| 212 | H9 | C9 | C10 | 119.8 |
| 213 | H9 | C9 | C10 | 119.8 |
| 214 | I1 | Cu1 | I2 | 110.19(2) |
| 215 | I1 | Cu1 | Cu1 | 58.41(2) |
| 216 | I1 | Cu1 | Cu2 | 111.13(2) |
| 217 | I1 | Cu1 | I1 | 109.18(2) |
| 218 | I1 | Cu2 | I2 | 110.06(2) |
| 219 | I1 | Cu2 | Cu1 | 58.41(2) |
| 220 | I1 | Cu2 | I2 | 113.46(2) |
| 221 | I1 | Cu1 | P1 | 107.82(4) |
| 222 | I1 | Cu1 | Cu2 | 109.12(2) |
| 223 | I1 | Cu1 | I1 | 109.18(2) |
| 224 | I1 | Cu1 | I2 | 113.69(2) |
| 225 | I1 | Cu1 | I2 | 110.19(2) |
| 226 | I1 | Cu2 | I2 | 110.06(2) |
| 227 | I2 | Cu1 | Cu1 | 105.23(2) |
| 228 | I2 | Cu1 | Cu2 | 58.59(2) |
| 229 | I2 | Cu1 | I1 | 113.69(2) |
| 230 | I2 | Cu2 | Cu1 | 105.27(2) |
| 231 | I2 | Cu2 | I2 | 103.83(2) |
| 232 | I2 | Cu2 | P2 | 111.87(4) |
| 233 | I2 | Cu2 | Cu1 | 103.39(2) |
| 234 | I2 | Cu2 | I1 | 113.46(2) |
| 235 | I2 | Cu2 | I2 | 103.83(2) |
| 236 | P1 | Cu1 | Cu2 | 143.02(4) |
| 237 | P1 | Cu1 | I1 | 110.81(4) |
| 238 | P1 | Cu1 | I2 | 105.08(4) |
| 239 | P1 | Cu1 | Cu1 | 149.68(4) |
| 240 | P1 | Cu1 | Cu2 | 138.04(4) |
| 241 | P1 | Cu1 | I1 | 107.82(4) |
| 242 | P1 | Cu1 | Cu2 | 143.02(4) |
| 243 | P1 | Cu1 | I1 | 110.81(4) |
| 244 | P1 | Cu1 | I2 | 105.08(4) |
| 245 | P2 | Cu2 | Cu1 | 144.68(4) |
| 246 | P2 | Cu2 | I1 | 107.56(4) |
| 247 | P2 | Cu2 | I2 | 110.04(4) |
| 248 | P2 | Cu2 | Cu1 | 144.69(4) |
| 249 | P2 | Cu2 | I2 | 111.87(4) |
| 250 | P2 | Cu2 | Cu1 | 144.68(4) |
| 251 | P2 | Cu2 | I1 | 107.56(4) |
| 252 | P2 | Cu2 | I2 | 110.04(4) |

Polymer Synthesis:

The above obtained copper (I) complex (CuI-diphenylphosphine complex having cubane-like structure) is dissolved in dry acetonitrile (or CH₂Cl₂) and placed in a flame-dried Schlenck tube under argon. divinylbenzene (4 equivalents) is added and the solution was heated at 70° C. during 7 hours. Then, styrene is introduced and the polymerization is initiated. After two hours, the solvent is removed under vacuum. The polystyrene solid residue is dried and may be investigated or treated further.

Synthesis of Conjugates:

Conjugates of conjugates with one type of ligands were prepared according to the following scheme:

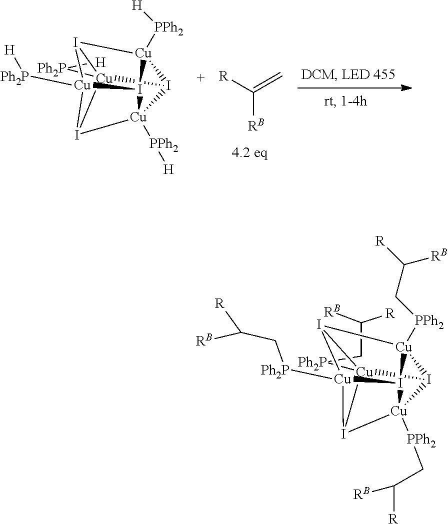

Herein, the reaction was conducted under UV light (e.g., at 455 nm) obtained by a light-emitting diode (LED) (e.g., LED 455). Dichloromethane (DCM) was used as solvent. The reaction was conducted at room temperature (rt) for 1-4 hours. The unsaturated moiety (B) (R—CH═CH₂) was used in slight excess of 4.2 equivalents (eq). For different unsaturated residues, dependent on the residue R, the following percentage yields (Rdt %) were obtained:

TABLE 4
Percentage yields (Rdt %) of conjugates, wherein the dashed
line indicates the binding site to a —CH═CH₂
moiety (acrylate derivative) and the waved line indicates the
binding site to a —C(CH₃)═CH₂ moiety (methacrylate
derivative).

| R | Rdt % |
|---|---|
| —Ph | 96 |
| —PhBr | 93 |
| 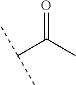 | 97 |
| 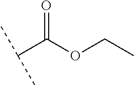 | 76 |
| 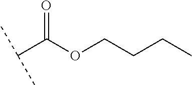 | 69 |
| 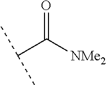 | 86 |
| 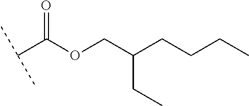 | 84 |
| 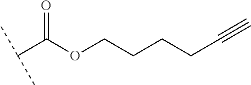 | 73 |
| 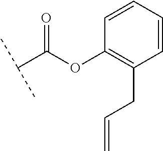 | 79 |
| 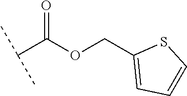 | 61 |
| 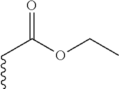 | 58 |
| 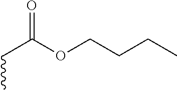 | 63 |
| 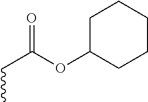 | 59 |
| 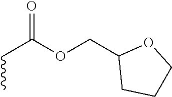 | 47 |

Alternative Process for Synthesis of Conjugates:

CuI-diphenylphosphine complex was dissolved in dry acetonitrile (or dichloromethane) and placed in a flame-dried Schlenck tube under argon. The acrylate derivative (here: styrene, para-phenylbromide or divinylbenzene) was added and the solution was heated at 70° C. during 7 hours. Then the mixture was cooled down to room temperature (RT) and the solvent was removed under vacuum. The solid residue was dissolved in dichloromethane and the solution was poured into diethyl ether. The complex precipitated directly and was filtrated and washed several times with diethyl ether and hexane. The product was dried under vacuum.

Alternative Process for Synthesis of Conjugates:

CuI-diphenylphosphine complex was dissolved in dry dichloromethane and placed in a flame-dried Schlenck tube under argon. The acrylate derivative was added and the solution was incubated for 6 hours. Then the mixture was cooled down to room temperature (RT) and the solvent was removed under vacuum. The solid residue was dissolve in dichloromethane and the solution was poured into diethyl ether or hexane. The complex precipitated directly and was filtrated and washed several times with diethyl ether and hexane. The product was dried under vacuum.

For example, the following conjugates were obtained:

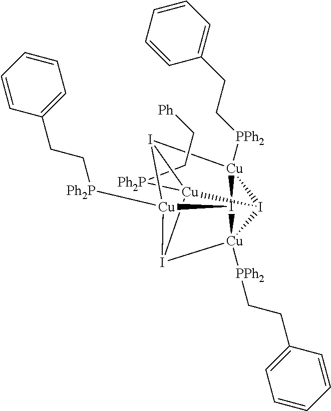

¹H NMR (500 MHz, CDCl₃): δ2.63 (m, 8 H), 2.91 (m, 8 H), 7.20 (m, 20 H), 7.28 (m, 24 H), 7.57 (m, 16 H) ppm. ¹³C NMR (126 MHz, CDCl₃): δ30.04 (d, J=16.1 Hz), 30,96 (d, J=6.2 Hz),125,128.35 (d), 128.45 (d, J=8 Hz),129.51, 133.15(d, J=12 Hz), 133.41(d, J=26 Hz), 142.63 (d, J=14.7 Hz) ppm. ³¹P {¹H} NMR (203 MHz, CDCl₃): δ-29.49 (br) ppm. IR (neat) v=3048, 3026, 1599, 1482, 1434, 1096, 1026, 938, 730, 688 cm⁻¹

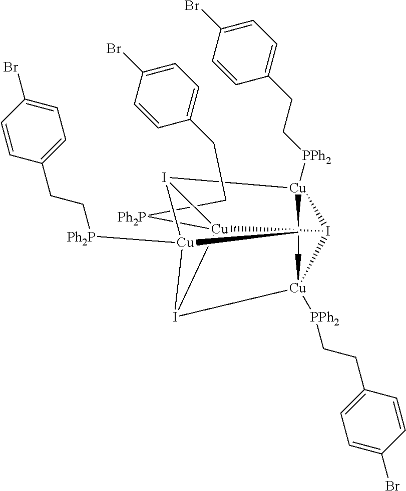

¹H NMR (500 MHz, CDCl₃): δ2.57 (m, 8 H), 2.81 (m, 8 H), 6.98 (m, 8 H), 7.28 (m, 32 H), 7.60 (m, 16 H) ppm. ¹³C NMR (126 MHz, CDCl₃): δ29.5 (d, J=16.1 Hz), 30,96 (d, J=6.2 Hz), 119, 128.53 (d, J=8 Hz),129.71, 130.04, 131.37, 133.15(d, J=13 Hz), 133.16(d), 141.4 (d, J=15 Hz) ppm. ³¹P {¹H} NMR (203 MHz, CDCl₃): δ-29.28 (br) ppm IR (neat) v=3043, 1482, 1431, 1099, 1070, 1009, 936, 844, 800, 732, 693 cm⁻¹

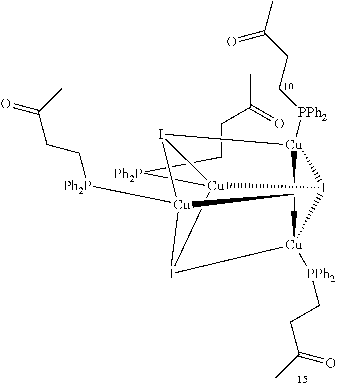

¹H NMR (500 MHz, CDCl₃): δ7.60-7.50 (m, 16 H), 7.39-7.32 (m, 8 H), 7.31-7.25 (m, 16 H), 2.69-2.56 (m, 8 H), 2.51-2.51 (m, 8 H), 1.91 (s, 12 H) ppm. ¹³C NMR (126 MHz, CDCl₃): δ173.17; 133.65 (d); 133.24 (d); 129.76; 128.68 (d); 38.75 (d); 29.80 (d, J=8 Hz); 22.19 ppm.³¹P {¹H} NMR (203 MHz, CDCl₃): δ-29.53 (br) ppm. Anal. Calcd for C₆₄ H₆₈Cu₄I₄O₄P₄: C, 43.02; H, 3.84. Found: C, 43.61; H, 3.92. IR (neat) v=3053, 2912, 1710, 1575, 1487, 1434, 1356, 1215, 1159, 1099, 868, 739, 693 cm−¹. ATG: 5% per mass lost at 317° C.

This compound has an emission maximum of 606 nm, an excitation maximum of 340 nm and a quantum yield of 17%.

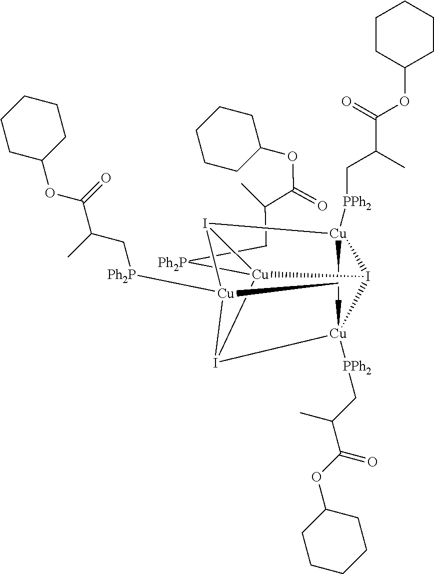

¹H NMR (500 MHz, CDCl₃): δ7.70 (m, 8 H), 7.65 (m, 8 H), 7.31 (m, 24 H), 4.44 (m, 4 H), 2.96 (m, 8 H), 2.80 (m, 8 H), 2.31 (m, 4 H), 1.72 (m, 8 H), 1.51 (m, 8 H), 1.27 (m, 16 H), 1.15 (d,¹J=7.0 Hz, 12 H) ppm. ¹³C NMR (126 MHz, CDCl₃): δ18.76(d, J=7 Hz), 23.56 (d, J=Hz), 25.39, 30.44 (d , J=15.5 Hz), 31.31 (d, J=6 Hz)), 36.35(d, J=7.0 Hz), 72.57, 128.30 (t), 129.27 (d), 133.02 (d, J=12.6 Hz)), 134.24(d, J=13.5 Hz)), 175.45(d, J=9 Hz)) ppm. ³¹P {¹ H} NMR (203 MHz, CDCl₃): δ-30 (br) ppm. IR (neat) v=3069, 2928, 2855, 1722, 1450, 1430, 1194, 1153, 1012, 912, 740, 695 cm⁻¹

This compound has an emission maximum of 569 nm, an excitation maximum of 300 nm and a quantum yield of 61%.

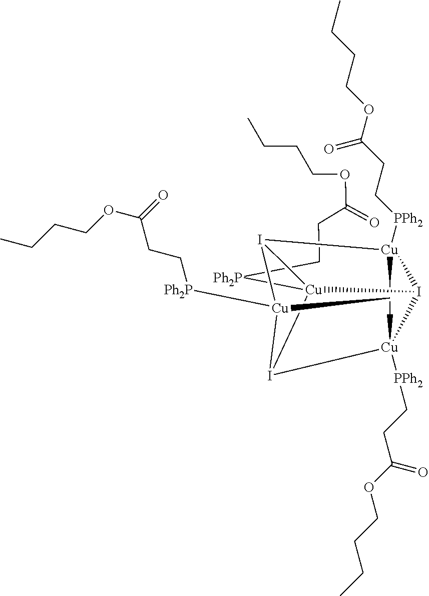

¹H NMR (500 MHz, CDCl₃): δ0.85 (t, 12 H), 1.29 (m, 8 H), 1.55 (m, 8 H), 2.55 (m, 16 H), 3.96 (t, 8 H), 7.31 (m, 24 H), 7.60 (m, 16 H) ppm. ¹³C NMR (126 MHz, CDCl₃): δ13.74, 19.15, 20.02 (d, J=17.3 Hz), 26.94, 30.66 (d, J=8 Hz), 64.58, 128.52 (d, J=9 Hz), 129.73, 132.81 (d, J=29 Hz), 134.78 (d, J=12.0 Hz)), 173.34 (d, J=17 Hz) ppm. ³¹P {¹H} NMR (203 MHz, CDCl₃): δ-29(br) ppm. IR (neat) v=3057, 2993, 2871, 1729, 1459, 1431, 1156, 1016, 734, 696 cm⁻¹

This compound has an emission maximum of 569 nm, an excitation maximum of 310 nm and a quantum yield of 60%.

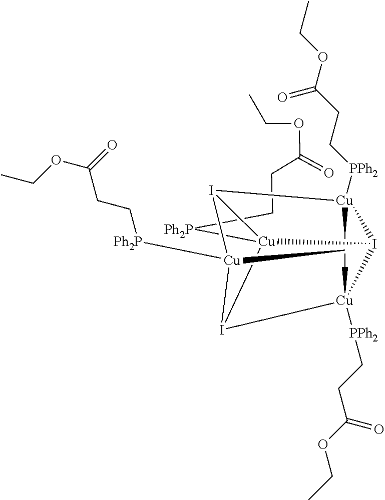

¹ H NMR (500 MHz, CDCl₃): δH=1.15 (t, 12 H), 2.52 (m, 16 H), 4.01 (m, 8 H), 7.28 (m, 24 H), 7.57 (m, 16 H) ppm.¹³C NMR (126 MHz, CDCl₃): δ14.19, 22.39(d, J=17.3 Hz), 29.5 (d, J=8 Hz), 60.59, 128.54(d, J=9 Hz),129.61, 132.85(d, J=28 Hz), 133.38(d, J=12.1 Hz),), 173.23(d, J=17 Hz) ppm.³¹P {¹H} NMR (203 MHz, CDCl₃): δ-29.69 ppm. IR (neat) v=3056, 2969, 2872, 1727, 1476, 1430, 1369, 1348, 1226, 1163, 1097, 1024, 733, 691 cm⁻¹. Anal. Calcd for C₆₄ H₆₈Cu₄I₄O₄P₄: C, 43.83; H, 4.02. Found: C, 41.76; H, 4.38. ATG : 5% lostof mass at 253° C. DSC : Pf: 128 ° C. recristallization at 61° C.

This compound has an emission maximum of 560 nm, an excitation maximum of 320 nm and a quantum yield of 99%.

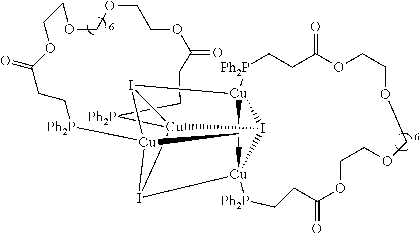

¹H NMR (500 MHz, CDCl₃) δ: 7.60 (m, 16 H), 7.32 (m, 24 H), 4.14 (m, 4 H), 3.97 (m, 4 H) , 3.63(m, 12 H) ,3.42 (m, 4 H), 2.58 (m, 16 H), 1.49 (m, 8 H), 1.28 (m, 8 H). ³¹P NMR (202 MHz, CDCl₃)δ: −30.21(br) ¹³C NMR (75 MHz, CDCl₃): 6 21.64 (d), 24.96, 27.36, 30.58 (d), 63.46, 69.57, 69.71, 127.50 (d), 128.69, 131.80 (d) 132.33 (d), 172.10 (d)

This compound has an emission maximum of 560 nm, an excitation maximum of 330 nm and a quantum yield of 52%.

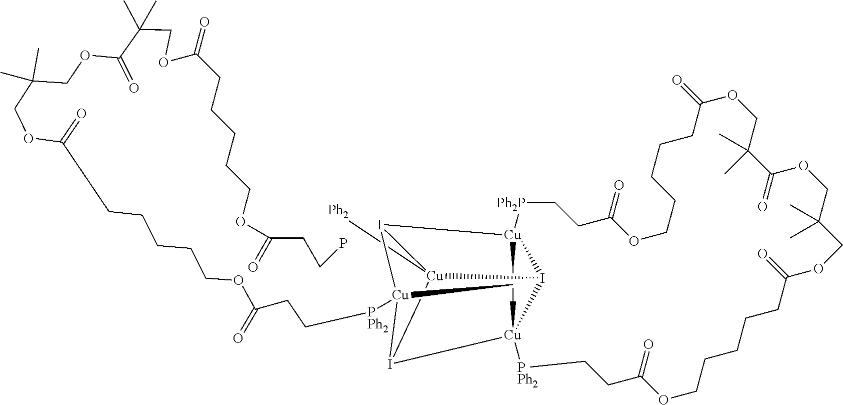

³¹P NMR (161 MHz, CDCl₃) δ: −31(br) ppm IR (neat) v=3055, 2951, 1730, 1475, 1429, 1218, 1147, 1031, 730, 693.cm⁻¹

Conjugates with two different types of ligands were prepared according to the following scheme. The method is according as described above.

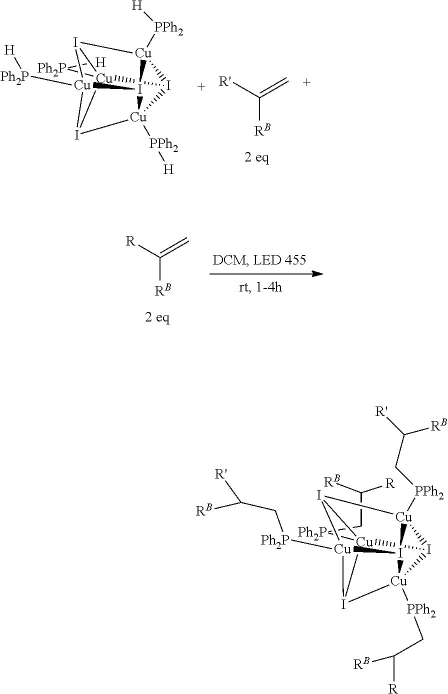

For example, the following conjugates were obtained:

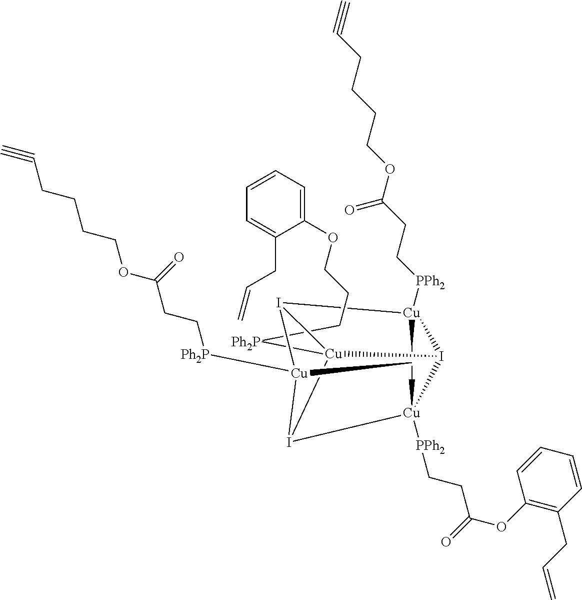

¹H NMR (600 MHz, CDCl₃): δH=1.53 (m, 4 H), 1.69 (m, 4 H), 1.96 (br, 2 H), 2.17 (td, 4 H), 2.58 (m, 8 H), 2.70 (m, 4 H), 2.86 (m, 4 H), 3.11 (d, 4 H), 4.01 (t, 4 H), 4.92 (m, 4 H), 5.77 (m, 2 H), 6.94 (m,2 H), 7.19 (m, 6 H), 7.34 (m, 24 H), 7.63 (m, 16 H) ¹³C{1H} NMR (75 MHz, CDCl3): δ C=18.10, 22.24 (d), 22.41(d), 24.83, 27.53, 29.46(d), 29.63(d),31.61, 34.57, 64.15, 84.18, 116.24, 122.37, 126.04, 127.30, 128.45 (d), 128.61 (d), 129.71, 129.82, 130.30, 131.87, 132.42 (d), 132.70(d), 133.30 (d), 133.40, 135.76, 148.93, 171.28 (d), 172.98 (d). ³¹P NMR (161 MHz, CDCl₃)δ: −29.68 (br)

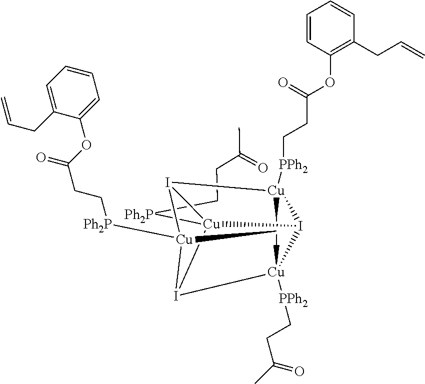

¹H NMR (600 MHz, CDCl₃): δH=1.94 (s, 6 H), 2.50 (m, 4 H), 2.63 (m, 8 H), 2.80 (m, 4 H), 3.19 (d, 4 H), 4.98 (m, 4 H), 5.80 (m, 2 H), 6.91 (m, 2 H), 7.16 (m, 6 H), 7.29 (m, 24 H), 7.58 (m, 16 H)

¹³C{1H} NMR (75 MHz, CDCl3): δ C=21.36 (d), 22.71, 29.57(d), 31.64, 34.81, 38.71(d), 116.32, 122.39, 126.10, 127.34, 128.70 (d), 128.90 (d), 129.87, 129.98, 130.34, 131.87, 132.14 (d), 132.65(d), 133.05 (d), 133.15, 135.87, 148.94, 171.27 (d), 207.30 (d).

³¹P NMR (161 MHz, CDCl₃)δ: −30 (br)

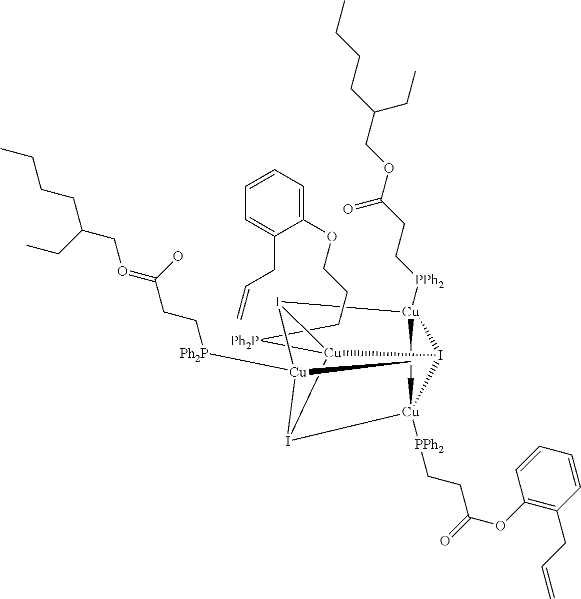

¹H NMR (600 MHz, CDCl₃): δH=0.94 (m, 12 H), 1.23 (m, 16 H), 1.51 (m, 2 H), 2.56 (m, 8 H), 2.72 (m, 4 H), 2.85 (m, 4 H), 3.16 (d, 4 H), 3.90 (m, 4 H), 4.93 (m, 4 H), 5.77 (m, 2 H), 6.94 (m, 2 H), 7.19 (m, 6 H), 7.34 (m, 24 H), 7.63 (m, 16 H)

¹³C{1H} NMR (75 MHz, CDCl3): δ C=10.93, 14.09, 22.21 (d), 22.34 (d), 22.96, 23.68, 28.87, 29.54 (d), 29.60 (d), 30.29, 34.56, 38.60, 67.29, 116.26, 122.37, 126.03, 127.29, 128.43(d), 128.60 (d), 129.68, 129.81, 130.29, 131.87, 132.41, 132.62, 133.29(d), 133.39 (d), 135.77, 148.93, 171.28 (d), 173.1 (d) ³¹P NMR (161 MHz, CDCl₃) δ: −29.9 (br)

1. A copper (I) complex of Formula (A) 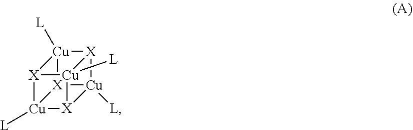
wherein:
each Cu is copper (I);
each X is independently from each other halogen;
each L is independently from each other an optionally substituted diarylphosphine residue of Formula (A1):
PHAr2 (A1),
wherein:
P is phosphorus;
H is hydrogen; and
each Ar is independently from each other an aryl residue that is unsubstituted or substituted by one or more substituents, wherein a substituent may optionally be or contribute to a linker that interconnects two ligands L with another;
wherein the phosphorus is bound to Cu; and
wherein said copper (I) complex has a neutral net charge.

2. The copper (I) complex of claim 1, wherein each X is iodine.

3. The copper (I) complex of claim 1, wherein each Ar is independently from each other a phenyl residue Ph that is unsubstituted or substituted by one or more substituents each independently from each other selected from the group consisting of a linear or branched, unsubstituted or substituted C₁-C₂₀-alkyl residue, a linear or branched, unsubstituted or substituted C₁-C₁₂-alkoxy residue and halogen, wherein each substituent may optionally be or contribute to a linker that interconnects two ligands L with another.

4. The copper (I) complex of any of claim 1, wherein each ligand L independently from each other has a structure of Formula (A2) 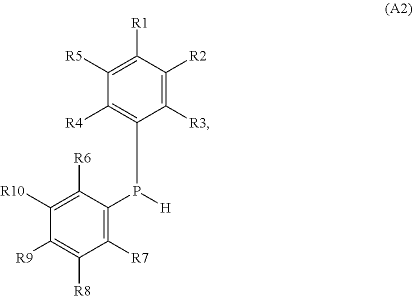
wherein R1 to R10 are independently from each other selected from the group consisting of hydrogen, a linear or branched, unsubstituted or substituted C₁-C₂₀-alkyl residue, or a linear or branched, unsubstituted or substituted C₁-C₁₂-alkoxy residue, and
wherein the phosphorus is bound to Cu.

5. The copper (I) complex of claim 1, wherein each ligand L independently from each other has a structure of Formula (A2) 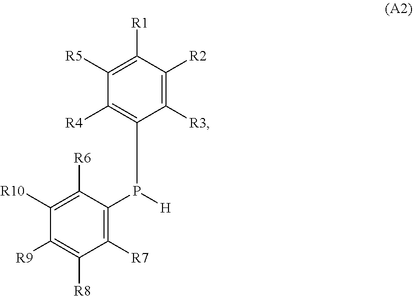
wherein each of R1 to R10 is independently from each other selected from the group consisting of hydrogen, methyl, ethyl, n-propyl, iso-propyl, or a C4-alkyl, and
wherein the phosphorus is bound to Cu.

6. The copper (I) complex of claim 1, wherein each L is a monovalent ligand of the same kind.

7. The copper (I) complex of claim 1, wherein two L are interconnected with another, thereby forming a bivalent ligand.

8. The copper (I) complex of any of claim 1, wherein said copper (I) complex has the following structure or Formula (A3): 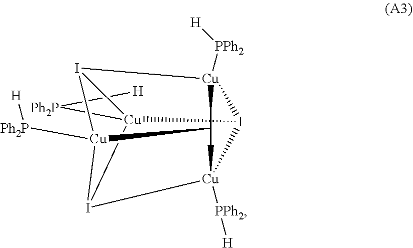
wherein each Ph is independently from each other an unsubstituted or substituted phenyl residue.

9. A method for generating a copper (I) complex of claim 1, said method comprising the following steps:
providing, in an inert atmosphere:
(a) copper (I) halide,
(b) an electronically neutral substituted ligand L as defined in claim 1, and
(c) a solvent in which components (a) and (b) are dissolved;
(ii) incubating the composition of step (i) at conditions allowing the formation of the copper (I) complex; and
(iii) optionally removing the solvent and obtaining a solid residue; and
(iv) optionally mixing the composition of step (ii) or a solution obtained by dissolving the solid residue of step (iii) with an anti-solvent, thereby forming a precipitate, and subsequently drying the precipitate.

10. A method for generating a cubane-like conjugate CC, said method comprising the following steps:
(I) providing, in an inert atmosphere:
(A) a copper (I) complex of claim 1,
(B) an unsaturated moiety to be conjugated thereto; and
(C) a solvent in which components (A) and (B) are dissolved;
(II) incubating the composition of step (I) at conditions allowing the reaction of the unsaturated moiety (B) with the phosphorus atom of the ligand L;
(III) optionally adding polymer monomers to the solution of step (II) and initiating polymerization; and
(IV) optionally removing the solvent.

11. A cubane-like conjugate CC obtainable from a method of claim 10.

12. A cubane-like conjugate CC comprising at least one copper (I) complex moiety of Formula (A-iii) 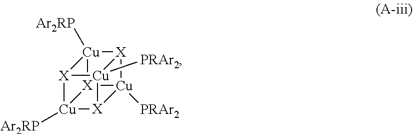
wherein:
each Cu is copper (I);
each X is independently from each other halogen;
each P is phosphorus;
each R is independently from each other hydrogen or —R^{a}—R^{b}, wherein in at least one ligand L residue R is —R^{a}—R^{b};
each Ar is independently from each other an aryl residue as defined in claim 1;
R^{a} is an unsubstituted or substituted C₁-C₂₀-alkylene residue; and
R^{b} is a polymeric residue, a C₂-C₂₀-(hetero)aromatic residue, or a C₁-C₂₀-alkoxy residue, wherein each hydrogen may optionally be substituted by an halogen or deuterium,
wherein said copper (I) complex has a neutral net charge.

13. An opto-electronic device containing a copper (I) complex of claim 1.

14. (canceled)

15. (canceled)

16. An opto-electronic device containing the cubane-like conjugate CC of claim 11.
